(19) United States
(12) Patent Application Publication
(10) Pub. No.: US 2007/0249502 A1
(43) Pub. Date: Oct. 25, 2007

(54) Composition for separating mixtures

(76) Inventors: Ian Procter, Bogis-Bossey (CH); Sobine Isabelle Azouani, Rue de Geneve (FR); Rolf Houbrichs, Geneve (CH)

Correspondence Address: DILWORTH & BARRESE, LLP, 333 EARLE OVINGTON BLVD., SUITE 702, UNIONDALE, NY, 11553, US

(21) Appl. No.: 11/296,795

(22) Filed: Apr. 24, 2006

(51) Int. Cl. A01N 31/00; C11D 3/02

(52) U.S. Cl. 504/351; 510/511

(57) ABSTRACT

Therefore, there is provided herein in one specific embodiment a composition comprising: a) at least one silicone surfactant, and where silicone of silicone surfactant (a) has the general structure of:
Mₐ¹M_{b}²D_{c}¹D_{d}²Tₑ¹T_{f}²Q_{g};
and,
2≦(a+b+c+d+e+f+g)≦100; and, b) a mixture comprising an aqueous phase, a solid filler phase and optionally an oil phase that is substantially insoluble in said aqueous phase.

### BACKGROUND OF THE INVENTION

(1) Field of the Invention

The present disclosure related to compositions for separating mixtures containing different phases.

(2) Description of the Prior Art

Aqueous and/or oil based mixtures are found in various commercial industries. The separation of these mixtures often is necessary to provide for reuse of various components in the mixtures or for proper treatment prior to the disposal of the separated mixture components. Mixtures can be separated by various means including mechanical, thermal, and chemical. The mechanical separation of mixtures can generally result in the at least partial separation of aqueous and/or oil phases that may be present in the mixture, but when these phrases are present in the form of an emulsion, mechanical separation often fails to provide a desirable degree of separation. Various chemical means have been provided for separation of emulsified phase mixtures, but various industries require still further levels of separation that hither to fore have not been adequately provided by conventional chemical means.

### BRIEF DESCRIPTION OF THE INVENTION

The present inventors have unexpectedly discovered that greatly improved separation of mixtures can be provided by the direct use of compositions comprising silicone surfactants and the mixture, which is to be separated.

Therefore, there is provided herein in one specific embodiment a composition comprising:

a) at least one silicone surfactant, and where silicone of silicone surfactant (a) has the general structure of:
Mₐ¹M_{b}²D_{c}¹D_{d}²Tₑ¹T_{f}²Q_{g};
where

M¹=R¹R²R³SiO_{1/2};

M²=R⁴R⁵R⁶SiO_{1/2};

D¹=R⁷R⁸SiO_{2/2};

D²=R⁹R¹⁰SiO_{2/2};

T¹=R¹¹SiO_{3/2};

T²=R¹²SiO_{3/2};

Q=SiO_{4/2}

where R¹, R², R³, R⁵, R⁶, R⁷, R⁸, R¹⁰, and R¹¹ are each independently selected from the group consisting of monovalent hydrocarbon radicals containing one to twenty carbon atoms, hydrogen, OH and OR¹³, where

R¹³ is a hydrocarbon group containing from 1 to about 4 carbon atoms,

R⁴, R⁹ and R¹² are independently hydrophilic organic groups, and

where the subscripts a, b, c, d, e, f and g are zero or positive integers for molecules subject to the following limitations:(a+b) equals either
(2+e+f+2g) or (e+f+2g), b+d+f≧1 and,
2≦(a+b+c+d+e+f+g)≦100; and,
b) a mixture comprising an aqueous phase, a solid filler phase and optionally an oil phase that is substantially insoluble in said aqueous phase.

### BRIEF DESCRIPTION OF THE DRAWING

FIG. 1: Transmission and back scattering data from the Turbiscan Lab instrument at 29 degrees Celsius (° C.) for a drilling mud from the Service Company treated with 2 weight % of Example 10B (Y-17014) based on the weight of the drilling mud sample (corresponding to 1g of silicone with 50g of mud).

### DETAILED DESCRIPTION OF THE INVENTION

Applicants have discovered in one specific embodiment a composition comprising a silicone surfactant and a mixture of different phases that can provide enhanced separation of said mixture of different phases.

It will be understood herein that the terms polyorganosiloxane and organopolysiloxane are interchangeable with one another.

It will be understood herein that all uses of the term centistokes was measured at 25 degrees celcius.

It will be understood that all specific, more specific and most specific ranges recited herein encompass all subranges there between.

It will be understood that the terms wetting agent and demulsifier as used herein can be interchangeable and silicone surfactant (a) can act both as a wetting agent and/or a demulsifier that can act separately or can act together.

In one specific embodiment herein silicone surfactant can be any commercially available or known silicone surfactant. In another specific embodiment herein silicone surfactant (a) can be any known or commercially and/or industrially used silicone surfactant that is naturally present or is conventionally added through known and/or conventional methods. In one other specific embodiment herein silicone of silicone surfactant (a) has the general structure described above.

In one specific embodiment herein it will be understood that the components described herein specifically, silicone surfactant (a), aqueous phase, solid filler phase and optionally oil phase of mixture (b) can all contain one or more of the other said components. In another specific embodiment herein any one or more of a component selected from the group consisting of silicone surfactant (a), mixture (b), aqueous phase of mixture (b), solid filler phase of mixture (b), oil phase of mixture (b), said aqueous phase, solid filler phase and said oil phase including said phases both prior to and/or after separation of mixture (b) can comprise two or more of the same and/or different aforementioned components as described herein.

It will also be understood herein that the phrases aqueous phase of mixture (b) and/or solid filler phase of mixture (b), and/or oil phase of mixture (b) is the respective, the aqueous phase and/or solid filler phase and/or oil phase as present, in mixture (b) prior to separation of mixture (b). It will be understood herein that phrases aqueous phase of separated mixture (b), and/or, solid filler phase of separated mixture (b), and/or oil phase of separated mixture (b) is respectively, the aqueous phase and/or, solid filler phase and/or and oil phase as present, after mixture (b) has been separated.

In one specific embodiment herein it will be understood that R¹, R², R³, R⁵, R⁶, R⁷, R⁸, R¹⁰, and R¹¹ are each independently selected from the group consisting of monovalent hydrocarbon radicals containing one to twenty carbon atoms, hydrogen, OH and OR¹³, more specifically methyl, hydrogen, OH and OR¹³, even more specifically methyl, OH, methoxy and ethoxy, and most specifically methyl and OH; where R¹³ is a hydrocarbon group containing from 1 to about 4 carbon atoms; and also as R¹, R², R³, R⁵, R⁶, R⁷, R⁸, R¹⁰, and R¹¹ are further described herein.

In another specific embodiment herein it will be understood that R⁴, R⁹ and R¹² are independently hydrophilic organic groups selected from the group consisting of Z¹, Z², Z³, Z⁴, Z⁶, Z⁸ and Z⁹ as described herein; and also as R⁴, R⁹ and R¹² are further described herein.

In yet another specific embodiment herein it will be understood that 2≦(a+b+c+d+e+f+g)≦100, more specifically, 2≦(a+b+c+d+e+f+g)≦75, more specifically, 2≦(a+b+c+d+e+f+g)≦50, even more specifically, 2≦(a+b+c+d+e+f+g)≦30, and most specifically, 2≦(a+b+c+d+e+f+g)≦20; and also as (a+b+c+d+e+f+g) are further described herein.

In yet another specific embodiment herein it will be understood that 2≦(a+b+c+d)≦100, more specifically, 2≦(a+b+c+d)≦75, even more specifically, 2≦(a+b+c+d)≦50, and yet even more specifically, 2≦(a+b+c+d)≦30, and most specifically, 2≦(a+b+c+d)≦20; and, also as (a+b+c+d) are further described herein.

In yet another specific embodiment herein it will be understood that a+b is about 2; and, also as a+b is further described herein.

In yet another specific embodiment herein it will be understood that c is specifically of from 0 to 10, more specifically of from 0 to 8 and most specifically of from 0 to 5; and, also as c is further described herein.

In yet even another specific embodiment herein it will be understood that d is specifically of from 1 to 10, more specifically of from 1 to about 6 and most specifically of from 1 to 3; and, also as d is further described herein.

In one more specific embodiment
R⁴, R⁹ and R¹² are independently hydrophilic organic groups selected from the group consisting of Z¹, Z², Z³, and Z⁸ where,
Z¹ is at least one polyoxyalkylene group having the general formula B¹O(CₕH₂ₕO)ₙR¹⁴ where B¹ is an alkylene radical containing from 2 to about 4 carbon atoms, specifically vinyl, allyl, and methallyl,
R¹⁴ is specifically a hydrogen atom, or a hydrocarbon radical containing from 1 to about 4 carbon atoms, more specifically where R¹⁴ is CH₃ or H, and most specifically, where R¹⁴ is hydrogen;
n is 1 to 100;
h is 2 to 4 which provides at least one polyoxyalkylene group selected from the group consisting of polyoxyethylene, polyoxypropylene, polyoxybutylene and combinations thereof, provided that at least about 10 molar percent of the at least one polyoxyalkylene group is polyoxyethylene;
Z² has the general formula B² (OH)ₘ
where B² is a hydrocarbon containing from 2 to about 20 carbon atoms and optionally containing oxygen and/or nitrogen groups, such as the non-limiting examples having the general formulas
   C₃H₆OCH₂CHOHCH₂OH,
   C₃H₆OCH₂C(CH₂OH)₂C₂H₅
   C₃H₆OCONHC₂H₄OH
   CH(CH₂OH)C₂H₄OH
, and m is sufficient to provide hydrophilicity, specifically m is from about 1 to about 20
Z³ is the reaction product of an epoxy adduct such as the non-limiting example of an AGE (allyl glycidyl ether) functional silicone, with a hydrophilic primary or secondary amine;
Z⁸ is at least one polyoxyalkylene group having the general formula:
   OB⁷O(CₕH₂ₕO)ₙR¹⁴
where B⁷ is an alkyl bridge containing from 2 to about 12 carbon atoms or an aryl bridge containing from 2 to about 12 carbon atoms;
R¹⁴ is specifically, hydrogen, or a hydrocarbon radical containing from 1 to about 4 carbon atoms, more specifically, where R¹⁴ is CH₃ or H, and most specifically where R¹⁴ is hydrogen;
n is 1 to 100;
h is 2 to 4, which provides at least one polyoxyalkylene group selected from the group consisting of polyoxyethylene, polyoxypropylene, polyoxybutylene and combinations thereof, provided that at least about 10 weight percent of the at least one polyoxyalkylene group is polyoxyethylene; and, wherein, 2≦(a+b+c+d+e+f+g)≦100, specifically, 2≦(a+b+c+d+e+f+g)≦75, more specifically, 2≦(a+b+c+d+e+f+g)≦50, even more specifically, 2≦(a+b+c+d+e+f+g)≦30, and most specifically, 2≦(a+b+c+d+e+f+g)≦20.

In yet even another specific embodiment silicone of silicone surfactant (a) has the general structure of:
Mₐ¹M_{b}²D_{c}¹D_{d}²
where

M¹=R¹R²R³SiO_{1/2};

M²=R⁴R⁵R⁶SiO_{1/2};

D¹=R⁷R⁸SiO_{2/2};

D²=R⁹R¹⁰SiO_{2/2};

where R¹, has the same definitions as described above and further specifically is selected from the group consisting of monovalent hydrocarbon radicals containing one to six carbon atoms, hydrogen, OH and OR¹³, more specifically methyl, hydrogen, OH and OR¹³, even more specifically methyl, OH, methoxy and ethoxy, and most specifically methyl and OH, where R¹³ is a hydrocarbon group containing from 1 to about 4 carbon atoms, and

R², R³, R⁵, R⁶, R⁷, R⁸ and R¹⁰ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl,

where R¹³ is a hydrocarbon group containing from 1 to about 4 carbon atoms,

R⁴ and R⁹ are independently selected from the group consisting of Z¹, Z², Z³, and Z⁸ as described above,

where, a+b is about 2 and 2≦(a+b+c+d)≦75, more specifically, a+b is about 2 and 2≦(a+b+c+d)≦50, and even more specifically, a+b is about 2 and 2≦(a+b+c+d)≦30, and most specifically, a+b is about 2 and 2≦(a+b+c+d)≦20.

In yet another specific embodiment the above-described hydrophilic organic groups further comprise where R⁴, R⁹ and R¹² are defined as described above and further specifically are independently selected from the group consisting of Z², Z⁴, Z⁶ and Z⁹ where
Z⁴ has the general formula B¹O(C₂H₄O)ₚ(C₃H₆O)_{q}R¹⁴
where B¹ is an alkylene radical containing from 2 to about 4 carbon atoms, specifically vinyl, allyl, and methallyl,
R¹⁴ is specifically, hydrogen, or a hydrocarbon radical containing from 1 to about 4 carbon atoms, more specifically, where R¹⁴ is CH₃ or H, and most specifically, where R¹⁴ is hydrogen, p is 1 to 15, q≦10 and p≧q;
Z⁶ is selected from the general formula of: 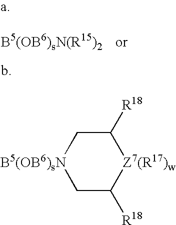
   where B⁵ and B⁶ are independently hydrocarbon radicals containing from 2 to about 6 carbon atoms, which can optionally contain OH groups,
   s is 0 or 1, and each R¹⁵ is independently hydrogen or an alkyleneoxide group having the general formula —(CᵤH₂ᵤO)ᵥ—R¹⁶ where u is 2 to 4 and v is 1 to 10, with the proviso that at least 50 molar percent of the alkyleneoxide groups are oxyethylene; R¹⁶ is hydrogen, or a hydrocarbon radical containing from 1 to about 4 carbon atoms; Z⁷ is either a nitrogen atom or an oxygen atom with the proviso that if Z⁷ is an oxygen atom, then w=0, and if Z⁷ is a nitrogen atom, then w=1,
   R¹⁷ is independently selected from an alkyleneoxide group having the general formula —(CᵤH₂ᵤO)ᵥ—R¹⁶ where u is 2 to 4 and v is 1 to 10, with the proviso that at least about 50 molar percent of the alkyleneoxide groups are oxyethylene;
   R¹⁸ groups are independently selected from the group consisting of hydrogen, OH, a hydrocarbon radical containing from 1 to about 4 carbon atoms and an alkyleneoxide group having the general formula —(CᵤH₂ᵤO)ᵥ—R¹⁶ where u is 2 to 4 and v is 1 to 10, with the proviso that at least 25 molar percent of the alkyleneoxide groups are oxyethylene;
   Z⁹ has the general formula OB⁷O(C₂H₄O)ₚ(C₃H₆O)_{q}R¹⁴
   where B⁷ is an alkyl bridge or an aryl bridge containing from 2 to about 12 carbon atoms, R¹⁴ is specifically, hydrogen, or a hydrocarbon radical containing from 1 to about 4 carbon atoms, more specifically where R¹⁴ is CH₃ or H, and most specifically where R¹⁴ is hydrogen,
   p=1 to 15, q≦10,and p≧q.

In yet even another specific embodiment silicone of silicone surfactant (a) has the general structure of:
Mₐ¹M_{b}²D_{c}¹D_{d}²
where

M¹=R¹R²R³SiO_{1/2};

M²=R⁴R⁵R⁶SiO_{1/2};

D¹=R⁷R⁸SiO_{2/2};

D²=R⁹R¹⁰SiO_{2/2};

where R¹, has the same definitions as described above and further specifically is selected from the group consisting of monovalent hydrocarbon radicals containing one to six carbon atoms, hydrogen, OH and OR¹³, more specifically methyl, hydrogen, OH and OR¹³, even more specifically methyl, OH, methoxy and ethoxy, and most specifically methyl and OH, where R¹³ is a hydrocarbon group containing from 1 to about 4 carbon atoms, and

R², R³, R⁵, R⁶, R⁷, R⁸ and R¹⁰ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl, where R¹³ is a hydrocarbon group containing from 1 to about 4 carbon atoms,

R⁴ and R⁹ are defined as described above and further are specifically independently selected from the group consisting of Z², Z⁴, Z⁶ and Z⁹ as described above, and a+b equals about 2 and specifically, c+d≦10 more specifically c+d≦8, and most specifically c+d≦5, and wherein, (a+b+c+d) can have any of the above described ranges.

In yet still even another more specific embodiment silicone of silicone surfactant (a) has the general structure of:
M²D_{c}¹M²
where

M²=R⁴R⁵R⁶SiO_{1/2};

D¹=R⁷R⁸SiO_{2/2};

where R⁵, R⁶, R⁷, and R⁸ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl, where R¹³ is a hydrocarbon group containing from 1 to about 4 carbon atoms,

R⁴ has the same definition as described above and further specifically is selected from the group consisting of Z², Z⁴, Z⁶ and Z⁹ as described above

and where c is specifically of from 0 to 10, more specifically of from 0 to 8 and most specifically of from 0 to 5.

In one other specific embodiment herein silicone of silicone surfactant (a) has the general structure of:
M¹D_{c}¹D_{d}²M¹

where

M¹=R¹R²R³SiO_{1/2};

D¹=R⁷R⁸SiO_{2/2};

D²=R⁹R¹⁰SiO_{2/2};

where R¹, has the same definitions as described above and further specifically is selected from the group consisting of monovalent hydrocarbon radicals containing one to six carbon atoms, hydrogen, OH and OR¹³, more specifically methyl, hydrogen, OH and OR¹³, even more specifically methyl, OH, methoxy and ethoxy, and most specifically methyl and OH, where R¹³ is a hydrocarbon group containing from 1 to about 4 carbon atoms, and

R², R³, R⁷, R⁸ and R¹⁰ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl, where R¹³ is a hydrocarbon group containing from 1 to about 4 carbon atoms, and

R⁹ is defined as described above and further specifically is selected from the group consisting of Z², Z⁴, Z⁶ and Z⁹, as described above, where c is specifically of from 0 to 10, more specifically of from 0 to 5 and most specifically of from 0 to 2, and d is specifically of from 1 to 10, more specifically of from 1 to about 6 and most specifically of from 1 to 3, and in one more specific embodiment, where c is from 0 to 2 and d is from about 1 to 3.

In another specific embodiment herein silicone of silicone surfactant (a) is a trisiloxane and has the general structure of:
M¹D²M¹
which is obtained from the hydrosilylation of a distilled silicone polymer having the general formula M¹D^{H}M¹ and unsaturated started alkylene oxide in sufficient molar excess to complete the hydrosilylation reaction,
where
M¹=R¹R²R³SiO_{1/2};
D^{H}=HR¹⁰SiO_{2/2};
D²=R⁹R¹⁰SiO_{2/2};
where R¹, R², R³, and R¹⁰ are defined as described above and further specifically are each independently selected from the group consisting of monovalent hydrocarbon radicals containing from 1 to 6 carbon atoms, hydrogen, OH and OR¹³, where R¹³ is a hydrocarbon group containing from 1 to about 4 carbon atoms and R⁹ is defined as described above and further specifically is selected from the group consisting of Z², Z⁴, Z⁶ and Z⁹.

In yet another specific embodiment herein silicone surfactant (a) is a low molecular weight ABA siloxane block copolymer where silicone of silicone surfactant (a) has the general structure M^{R}D_{c}¹M^{R} which is obtained from the hydrosilylation of silicone polymer having the general formula M^{H}D_{c}¹M^{H} and unsaturated started alkylene oxide and specifically present, in sufficient molar excess to complete the hydrosilylation reaction, where c is specifically 0 to 10, more specifically 0 to 8, and most specifically 0 to 5, D¹=R⁷R⁸SiO_{2/2}, M^{R}=R⁴R⁵R⁶SiO_{1/2}, M^{H}=HR⁵R⁶SiO_{1/2} and where R⁵, R⁶, R⁷, and R⁸ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl, and where R¹³ is a hydrocarbon group containing from 1 to about 4 carbon atoms and where R⁴ is defined as described above and further specifically is

C_{g}H_{2g}—O(C₂H₄O)ₚ(C₃H₆O)_{q}R¹⁴ and where R¹⁴ is specifically, hydrogen, or a hydrocarbon radical containing from 1 to about 4 carbon atoms, more specifically, where R¹⁴ is CH₃ or H, and most specifically, where R¹⁴ is hydrogen, g=2 to 4, specifically g=3; specifically p=1 to 12; more specifically p=2 to 10 and most specifically p=3 to 8; q≦6 more specifically q≦3 most specifically q=0 and p≧q.

In yet a further specific embodiment herein silicone surfactant (a) is a low molecular weight pendant siloxane copolymer where silicone of silicone surfactant (a) has the general structure M¹D_{c}¹D_{d}^{R}M¹ which is obtained from the hydrosilylation of silicone polymer having the general formula M¹D_{c}¹D_{d}^{H}M¹ and unsaturated started alkylene oxide in sufficient molar excess to complete the hydrosilylation reaction, where M¹=R¹R²R³SiO_{1/2}, D¹=R⁷R⁸SiO_{2/2},

D^{R}=R⁹R¹⁰SiO_{2/2}, D^{H}=HR¹⁰SiO_{2/2}, and where c is specifically of from 0 to 10, more specifically of from 0 to 5 and most specifically of from 0 to 2, and d is specifically of from 1 to 10, more specifically of from 1 to about 6 and most specifically of from 1 to 3, and in one more specific embodiment, when specifically c is 0 to 3 and d=1 to 3, or more specifically either c is ≦1 and d is about 1 to about 3, or, c is about 1 to about 2 and d is about 1 to about 2, or yet even more specifically c=0 and d is about 1 to about 2 or most specifically, c is about 1 and d is about 1, and where c is from 0 to about 2 and d is from about 1 to about 3,

where R¹, has the same definitions as described above and further specifically is selected from the group consisting of monovalent hydrocarbon radicals containing one to six carbon atoms, hydrogen, OH and OR¹³, more specifically methyl, hydrogen, OH and OR¹³, even more specifically methyl, OH, methoxy and ethoxy, and most specifically methyl and OH, where R¹³ is a hydrocarbon group containing from 1 to about 4 carbon atoms, and

R², R³, R⁷, R⁸ and R¹⁰ have the same definitions as described above and further specifically are each independently selected from the group consisting of monovalent hydrocarbon radicals containing one to six carbon atoms, hydrogen, OH and OR¹³, more specifically methyl, OH, methoxy and ethoxy, and most specifically methyl, where R¹³ is a hydrocarbon group containing from 1 to about 4 carbon atoms,

and where R⁹ is defined as described above and further specifically is independently C_{g}H_{2g}—O(C₂H₄O)ₚ(C₃H₆O)_{q}R¹⁴ and where specifically R¹⁴ is hydrogen, or a hydrocarbon radical containing from 1 to about 4 carbon atoms, more specifically R¹⁴ is CH₃ or hydrogen and most specifically R¹⁴ is hydrogen, g=2 to 4, specifically, g=3, specifically p=1 to 12, more specifically p is 2 to 10, most specifically p is 3 to 8, specifically q≦6 and more specifically q≦3 and most specifically q=0, and p≧q.

In yet even another specific embodiment herein silicone surfactant (a) is a trisiloxane siloxane copolymer where silicone of silicone surfactant (a) has the general structure M¹D^{R}M¹ which is obtained from the hydrosilylation of a distilled silicone polymer having the general formula M¹D^{H}M¹ and unsaturated started alkylene oxide in sufficient molar excess to complete the hydrosilylation reaction, where M¹=R¹R²R³SiO_{1/2}, D^{R}=R⁹R¹⁰SiO_{2/2}, D^{H}=HR¹⁰SiO_{2/2}, where R¹, R², R³, and R¹⁰, are defined as described above and further are specifically each independently selected from the group consisting of CH₃, hydrogen, OH and OR¹³, more specifically CH₃, and where R¹³ is a hydrocarbon group containing from 1 to about 4 carbon atoms, and where R⁹ is C_{g}H_{2g}—O(C₂H₄O)ₚ(C₃H₆O)_{q}R¹⁴, and where R¹⁴ is hydrogen, or a hydrocarbon radical containing from 1 to about 4 carbon atoms, more specifically, CH₃ or H, and most specifically, hydrogen, g=2 to 4, specifically g=3, specifically p=1 to 12, more specifically p is 2 to 8, most specifically p is 3 to 8, specifically q≦6 and more specifically q≦3 and most specifically q=0, and p≧q.

In yet still another further specific embodiment silicone surfactant (a) can be used at a concentration of specifically from about 0.001 weight percent to about 5 weight percent, more specifically from about 0.05 weight percent to about 4 weight percent and most specifically from about 0.1 weight percent to about 3 weight percent, based on the total weight of the composition, to enhance phase separation.

In one specific embodiment herein, mixture (b) can be any known or commercially available and/or industrially used mixture with the proviso that the mixture contains at least an aqueous phase and solid filler phase, and optionally an oil phase. In another specific embodiment herein mixture (b) can be any known or commercially and/or industrially used mixture that is naturally present or is conventionally added through known and/or conventional methods. In one specific embodiment herein it will be understood that mixture (b) comprising aqueous phase, solid filler phase, and oil phase when present, can all be intermixed so that each phase contains some amount of the other phases present and/or some amount of silicone surfactant (a). In another specific embodiment it will be understood herein that solid filler phase can comprise solid filler and any other phase as described herein and/or silicone surfactant (a) as described herein. In yet another specific embodiment herein solid filler phase can comprise only solid filler. In yet a further specific embodiment mixture (b) can comprise a drilling mud, a shale oil deasher sludge, a refinery sludge, a soil from a refinery and/or industrial site, a soil from the site of leaking fuel storage tank, a slop crude mixture, a pharmaceutical emulsion, such as the non-limiting example of a bioprocessing emulsion optionally containing a fermentation product, a tar-oil sand and combinations thereof. In one specific embodiment it will be understood herein that tar-oil sand can be any tar sand and does not necessarily have to contain oil.

In one specific embodiment there is provided a process for separating a mixture comprising:

a) combining at least one silicone surfactant (a), as described herein, and

b) a mixture comprising an aqueous phase, a solid filler phase and optionally an oil phase that is substantially insoluble in said aqueous phase, and providing for separation of any one or more of said aqueous phase, said solid filler phase, and if present, said oil phase to provide a separated mixture (b).

In one specific embodiment herein mixture (b) can be separated before and/or after a mechanical separation process as in conventionally known to those skilled in the art.

In another specific embodiment herein mixture (b) is a mixture selected from the group consisting of a mixture resulting from an oil spill, a mixture resulting from a pipeline break, a mixture resulting from a leaking fuel tank, a mixture resulting from an industrial operation, and combinations thereof.

In another specific embodiment herein there is provided a process for providing for separated mixture (b) comprises agitating said combined silicone surfactant (a), as described herein and said mixture (b), and optionally adding additional fluid, as described herein, and/or optionally heating mixture (b).

In one specific embodiment silicone surfactant (a) can be a blend of materials such as a blend of silicone surfactants and organic compound with non-limiting examples of the organic compound of such as alkyl alcohol polyglycol ether, polyalkylene glycol, alkyl aryl alcohol polyglycol ether and combinations thereof. In another specific embodiment herein said blend of silicone surfactant and additive compound can be selected from Y-17188, Y-17189, Y-17190 & Y-17191 (where; Y-17188 is a blend of Y-17015 (40 wt %) and UCON 50H1500 (60 wt %); Y-17189 is a blend of Pluronic 17R2 (40 wt %), Rhodasurf DA-530 (30 wt %) and Y-17015 (30 wt %); Y-17190 is a blend of Genapol X50 (30 wt %); Pluronic L-62 (40 wt %) and Y-17015 (30 wt %); Y-17191 is a blend of Y-17015 (93.3 wt %) and Pluronic 17R2 (6.7 wt %)). UCON 50H1500 is available from Dow Chemicals; Pluronic 17R2 and Pluroninc L-62 are available from BASF Chemicals; Rhodasurf DA-530 is available Rhodia Chemicals; Genapol X50 is available from Clariant chemicals.

In another specific embodiment herein there is provided a process comprising where combined surfactant (a), as described herein, and mixture (b) is part of a recycle stream from a previous separation of any one or more of said aqueous phase, said solid filler phase, and if present said oil phase. In one more specific embodiment as described herein there is provided a process where separated mixture (b) is a separated mixture of the non-limiting examples selected from the group consisting of a drilling mud, a shale oil deasher sludge, a refinery sludge, a soil from a refinery and/or industrial site, a soil from the site of leaking fuel storage tank, a slop crude mixture, a pharmaceutical emulsion, such as the non-limiting example of a bioprocessing emulsion optionally containing a fermentation product, a tar-oil sand, and combinations thereof.

In one specific embodiment herein there is provided a process comprising where said separated mixture (b) is separated in a shorter period of time than required for a process for separating an identical mixture (b) which comprises combining surfactant other than silicone surfactant (a) as described herein and identical mixture (b).

In another specific embodiment there is provided a process further comprising where said separated mixture (b) is more completely separated than an identical mixture (b) present in a process for separating a mixture which comprises combining surfactant other than silicone surfactant (a) as described herein and identical mixture (b).

In another specific embodiment there is provided a process further comprising where said separated mixture (b) has any one or more of said aqueous phase, said solid filler phase and if present said oil phase each containing a smaller amount of contaminants than a process for separating an identical mixture (b) which comprises combining surfactant other than silicone surfactant (a) as described herein and identical mixture (b).

In another specific embodiment there is provided a process further comprising where any interface in separated mixture (b) between any one or more of said aqueous phase, said solid filler phase and if present said oil phase is sufficiently distinct to provide for a smaller amount of interface that needs to be isolated than a process for separating an identical mixture (b) which comprises combining surfactant other than silicone surfactant (a) as described herein and identical mixture (b).

In another specific embodiment herein there is provided a process further comprising where aqueous phase of separated mixture (b) contains specifically of from about 0 to about 1000 parts per million (ppm), more specifically of from about 0 to about 100 ppm, and most specifically of from about 0 to about 25 ppm of hydrocarbon contamination.

In another specific embodiment herein there is provided a process further comprising where aqueous phase of separated mixture (b) contains specifically of from about less than about 90 weight percent more specifically less than about 50 weight percent and most specifically less than about 10 weight percent of the amount of heavy metal that was present in mixture (b) prior to mixture (b) being separated, said weight percent being based on the total weight of heavy metal in mixture (b) prior to mixture (b) being separated. In another specific embodiment herein, there is provided a process further comprising where aqueous phase of separated mixture (b) contains specifically of from about 0 to about 0.1 ppm of heavy metal. In another specific embodiment herein said heavy metal is selected from the group consisting of lead, cadmium, arsenic, bismuth, mercury, and combinations thereof.

In another specific embodiment herein there is provided a process further comprising where aqueous phase of separated mixture (b) contains specifically of from about 0 to about 0.5 weight percent, more specifically of from about 0 to about 0.1 weight percent, and most specifically of from about 0 to about 0.02 weight percent of solid filler phase, said weight percents being based on the total weight of aqueous phase of separated mixture (b).

In another specific embodiment herein there is provided a process further comprising where solid filler phase of separated mixture (b) contains specifically less than about 90 weight percent, more specifically less than about 80 weight percent, and most specifically less than about 70 weight percent of the amount of aqueous phase that was present in solid filler phase prior to separation of mixture (b), said weight percents being based on the total weight of aqueous phase in mixture (b) prior to mixture (b) being separated.

In one more specific embodiment, oil based drilling muds are used in the sinking of boreholes, especially deep level boreholes sunk in the search for hydrocarbons (including gas), to maintain pressure against the producing formation to prevent blowouts, to lubricate the drill pipe, to cool the rock drilling bit and act as a carrier for excavated drill cuttings. The drilling fluid or mud is pumped down the drill pipe through nozzles in the drill bit at the bottom of the borehole and up the annulus between the drill pipe and borehole wall. Drilled cuttings generated by the drill bit are taken up with the mud and transported to the surface of the borehole where they are separated from the drilling mud and discarded. The drilling mud is then cleaned and re-used. The drill pipe is then able to operate freely within the borehole.

In another specific embodiment herein, oil based drilling mud is generally used in the form of invert emulsion mud. In one specific embodiment an invert emulsion mud consists of three-phases: an aqueous phase, a solid filler phase and an oil phase. In another specific embodiment besides the hydrocarbon oil the drilling fluids typically include a solid filler, usually inorganic which is added to build viscosity and density; an emulsifier (surfactants with low HLB such as fatty acids) to help suspend particulate materials and aid wetting, as described herein; wetting agents to help wetting a variety of the substrates that the fluid comes into contact with (wetting agents can be fatty acids as described herein), the emulsifier serves to lower the interfacial tension of the liquids so that the aqueous phase may form a stable dispersion of fine droplets in the oil phase. In one embodiment herein after a certain period of drilling, the drilling mud becomes charged with more water, some crude oil and drill cuttings, changing the physical properties of the drilling mud (increase of viscosity); then the mud needs to be removed from the well and is recycled. In one specific embodiment, the big cuttings are first separated mechanically and the rest of the mud is put in a tank for further phase separation.

In one specific embodiment herein there is provided a process further comprising where drilling mud comprises drill cuttings, from a well drilling operation using an oil-based drilling fluid or mud, further comprising where providing for separation of mixture (b) comprises cleaning drilling mud and oil from said drill cuttings sufficiently for environmentally safe disposal. In one specific embodiment, environmentally safe disposal can comprise where the cleaned cuttings are essentially nontoxic and can be disposed of on land without the need for the special procedures required for disposal of toxic waste.

In another specific embodiment herein, in many offshore drilling operations when an oil-based drilling mud has been used, environmental protection has made it necessary to accumulate the drill cuttings and transport them to shore for disposal in a toxic waste site. This can be a significant element of expense in the total cost of the well. Thus, in a more specific embodiment, there is provided a process further comprising where said well drilling operation comprises a drill cuttings mixture produced by an offshore well and further comprising where said drill cutting mixture can be returned to the sea near the offshore well and/or transported to land for disposal. In another specific embodiment there can be a cost savings in conducting said process for separating a drilling mud in an offshore well as described above using combination of silicone surfactant (a) and mixture (b) as described herein. In another specific embodiment herein any mixture (b) as described herein can be separated in an offshore operation as is described herein using combination of silicone surfactant (a) and mixture (b) as described herein.

In one specific embodiment herein there is provided a process to remove specifically from about 1 to about 99 weight percent of aqueous phase of mixture (b), more specifically from about 20 to about 98 weight percent of aqueous phase of mixture (b), and most specifically of from about 50 to about 97 weight percent of aqueous phase of mixture (b) based on the total weight of aqueous phase in mixture (b) prior to separation of mixture (b).

In one specific embodiment herein there is provided a process to remove specifically from about 1 to about 99 weight percent of oil phase, more specifically from about 20 to about 98 weight percent of oil phase, and most specifically of from about 50 to about 97 weight percent of oil phase based on the total weight of oil phase prior to separation of mixture (b) as described herein, specifically prior to separation of a drilling mud containing drill cuttings using the composition described herein.

In another specific embodiment herein, the properties of drilling mud recovered from cuttings as described herein are not significantly adversely affected; the recovered drilling mud can be returned to an active mud system without danger to the properties thereof.

In another specific embodiment herein there is provided a process for separating suspended solids from slop crude, such as the non-limiting example of remaining crude after the major refining of the crude, using any of the processes described herein. In one specific embodiment the slop crude is added to a desalter along with fresh crude oil to get dissolved and washed and refined. In another specific embodiment the aim is to increase the yield of the refinery. In one specific embodiment herein any of the processes described herein could drop all suspended matter (aqueous phase, solid filler phase and oil phase) out of the crude oil (or mixture (b)) to the bottom of the desalter so that they are removed along with the brine. In another specific embodiment slop crude can comprise a broad range of hydrocarbon emulsions encountered in crude oil production, refining and chemical processing, such as the non-limiting examples of oilfield production emulsions, refinery desalting emulsions, refined fuel emulsions, and recovered oil emulsions. In a more specific embodiment slop crude oil can comprise used lubricant oils, and recovered oils in the steel and aluminum industries.

In another specific embodiment herein there is provided a process for the treatment of a pharmaceutical emulsion, using any of the processes described herein, where said emulsion can be produced in preparation of pharmaceuticals and other bioprocessing applications involving fermentation, such emulsion containing fermentation product and most specifically includes a pharmaceutical that is desired to be separated from said emulsion.

In yet a further specific embodiment herein there is provided a process for the treatment of tar-oil sand(s), since these systems are quite similar to the drilling muds, with an emulsion of solid particles, oil and water. In a more specific embodiment the process of treating tar-oil sand(s) can comprise extracting the crude oil adsorbed on the sand particles and/or dedusting solids containing hydrocarbon oils. In another embodiment herein, herein described tar-oil sand(s) can have additional water added to the tar-oil sand(s) to help with the separation process.

In more specific embodiment herein mixture (b) can comprise any aqueous phase. In another specific embodiment aqueous phase can be any known or commercially and/or industrially used aqueous phase that is naturally present or is conventionally added through known and/or conventional methods. In one embodiment aqueous phase of mixture (b) prior to separation of mixture (b) contains water in an amount of specifically from about 1 to about 99 weight percent, more specifically of from about 5 to about 90 weight percent and most specifically of from about 10 to about 60 weight percent of mixture (b) prior to separation of mixture (b), with weight percent being based upon the total weight of mixture (b) prior to separation of mixture (b). In another specific embodiment herein mixture (b) prior to separation can further comprise an additional fluid(s), specifically water that originates from the use of a filtration process prior to separation of mixture (b); said additional fluids being included in the above described weight percents of aqueous phase present in mixture (b) prior to separation of mixture (b). In yet a further specific embodiment any one or more of mixture (b); phases of mixture (b) such as aqueous phase, aqueous phase containing additional fluid, specifically water, which can comprise anything that water of aqueous phase can comprise as described herein, solid filler phase and oil phase and combinations thereof, can be heated prior to and/or after separation of mixture (b) to facilitate separation, as can any process described herein.

In one other specific embodiment herein, water of said aqueous phase further comprises inorganic salt(s) such as the non-limiting examples selected from the group consisting of sodium chloride, calcium chloride, magnesium chloride, sodium sulfates, magnesium sulfate, sodium carbonate, calcium carbonate, magnesium carbonate and combinations thereof in an amount of up to about saturation of aqueous phase. In one specific embodiment the amount of inorganic salts up to about 0 to about 20 weight percent, more specifically of from about 0.1 to about 15 weight percent, and most specifically of from about 1 to about 10 weight percent of mixture (b), based on the total weight of mixture (b) prior to separation of mixture (b). In one specific embodiment inorganic salt(s) can be present in an amount up to about saturation of said aqueous phase and/or mixture (b).

In one more specific embodiment herein, mixture (b) also contains an additional silicone surfactant such as the non-limiting example of silicone surfactant (a). The amount of additional silicone surfactant such as the non-limiting example of silicone surfactant (a) that is contained in mixture (b) is specifically of from about 0.0001 to about 4 weight percent more specifically of from about 0.05 to about 3.5 weight percent, and most specifically of from about 0.1 to about 2.5 weight percent of mixture (b) based on the total weight of mixture (b) prior to separation of mixture (b). In one specific embodiment herein the aqueous phase of mixture (b) prior to separation of mixture (b) can contain silicone surfactant (a) as an impurity or silicone surfactant (a) can be solvated in aqueous phase (a) in known and conventional methods.

In another specific embodiment herein mixture (b) can comprise solid filler phase. In another more specific embodiment solid filler phase can be any known or commercially and/or industrially used solid filler that is naturally present or is conventionally added through known and/or conventional methods.

In yet still further a specific embodiment herein, solid filler phase of mixture (b) comprises solid filler selected from the group consisting of drill cuttings; siliceous solid, where siliceous solid can further comprise the non-limiting examples of sand and quartz; rock; gravel; soil; ash; mineral; metal and metal ores, such as the non-limiting examples of iron, iron ore, and precious metals such as the non-limiting examples of gold and silver; a metal part; a glass plate; cellulosic material, such as the non-limiting examples of bark, straw and sawdust; weighting agent such as the non-limiting examples of barite, galena, ilmenite, iron oxides, (specular or micaceous hematite, magnetite, calcined iron ores), siderite, and calcite; suspending agent such as the non-limiting examples of organophilic clay (organoclay), which can be selected from the non-limiting group consisting of attapulgite, bentonite, hectorite, saponite and sepiolite; fluid loss control agent such as the non-limiting examples of asphaltic materials and organophilic humates, and combinations thereof of any of the above described solid fillers. In another specific embodiment solid filler of solid filler phase can comprise any of the organic or inorganic materials described in U.S. Pat. No. 4,508,628, the contents of which are incorporated by reference herein in its entirety. In another specific embodiment herein solid filler phase comprises of specifically from about 1 to about 99 weight percent, more specifically of from about 10 to about 80 weight percent and most specifically of from about 20 to about 60 weight percent of mixture (b), based on the total weight of mixture (b) prior to separation of mixture (b). In one more specific embodiment herein drill cuttings comprise of specifically from about 0 to about 25 weight percent, more specifically of from about 2 to about 20 weight percent and most specifically of from about 5 to about 15 weight percent of mixture (b) based on the total weight of mixture (b) prior to separation of mixture (b).

In another specific embodiment herein, it is well known that organic compounds which contain a cation will react with clays which have an anionic surface and exchangeable cations to form organoclays. Depending on the structure and quantity of the organic cation and the characteristics of the clay, the resulting organoclay may be organophilic and hence have the property of swelling and dispersing or gelling in certain organic liquids depending on the concentration of organoclay, the degree of shear applied, and the presence of a dispersant. See for example the following U.S. patent Nos., all incorporated herein by reference in their entireties for all purposes: U.S. Pat. Nos. 2,531,427 (Hauser); 2,966,506 (Jordan); 4,105,578 (Finlayson and Jordan); 4,208,218 (Finlayson); and the book “Clay Mineralogy”, 2nd Edition, 1968 by Ralph E. Grim, McGraw-Hill Book Co., Inc., particularly Chapter 10—Clay Mineral-Organic Reactions, pp. 356-368—Ionic Reactions, Smectite, and pp. 392-401—Organophilic Clay-Mineral Complexes.

In another specific embodiment herein, the organophilic clays based on attapulgite and sepiolite generally allow suspension of the solid filler phase without drastically increasing the viscosity of the oil-mud, whereas the organophilic clays based on bentonite, hectorite, and saponite are gellants and appreciably increase the viscosity of the oil-based mud. In one embodiment, some clays (such as bentonite), can be used as viscosity builders in the drilling muds, and are modified to make them organophilic such that the layers in the clay separate from each other and adsorb oil exists.

In yet another specific embodiment herein, the organophilic clays based on attapulgite or sepiolite can have a milliequivalent ratio (ME ratio) from about 30 to about 50. The ME ratio (milliequivalent ratio) is defined as the number of milliequivalents of the cationic compound in the organoclay, per 100 grams of clay, 100% active clay basis. In one embodiment herein, organophilic clays based on bentonite, hectorite, or saponite can a ME ratio from about 75 to about 120. The optimum ME ratio will depend on the particular clay and cationic compound used to prepare the organoclay. In general it has been found that the gelling efficiency of organophilic clays in non-polar oleaginous liquids increases as the ME ratio increases. In one specific embodiment, the most specific organophilic clays, based on bentonite, hectorite, or saponite, can have an ME ratio in the range from 85 to about 110.

In another specific embodiment herein, the organic quaternary compounds useful herein are selected from the non-limiting group consisting of quaternary ammonium salts, quaternary phosphonium salts, and mixtures thereof. In one specific embodiment herein some non-limiting representative quaternary phosphonium salts are disclosed in the following U.S. patent Nos., all incorporated herein by reference in their entireties: U.S. Pat. Nos. 3,929,849 (Oswald) and 4,053,493 (Oswald). In another specific embodiment, some non-limiting representative quaternary ammonium salts are disclosed in U.S. Pat. No. 4,081,496 (Finlayson), incorporated herein by reference herein in its entirety, in addition to the patents previously cited herein.

In one specific embodiment, the preferred quaternary compounds comprise a quaternary ammonium salt such as those described in U.S. Pat. No. 4,508,628 the contents of which are incorporated by reference herein in its entirety.

In another specific embodiment herein, some non-limiting quaternary ammonium cations are selected from the group consisting of trimethyl octadecyl ammonium, trimethyl hydrogenated tallow ammonium, trimethyl ricinoleyl ammonium, dimethyl didodecyl ammonium, dimethyl diotadecyl ammonium, dimethyl dicoco ammonium, dimethyl dihydrogenated tallow ammonium, dimethyl diricinoleyl ammonium, dimethyl benzyl octadecyl ammonium, dimethyl benzyl hydrogenated tallow ammonium, dimethyl benzyl ricinoleyl ammonium, methyl benzyl dioctadecyl ammonium, methyl benzyl dihydrogenated tallow ammonium, methyl benzyl diricinoleyl ammonium, methyl benzyl dicoco ammonium, methyl dibenzyl octadecyl ammonium, methyl dibenzyl hydrogenated tallow ammonium, methyl dibenzyl ricinoleyl ammonium, methyl dibenzyl coco ammonium, methyl trioctadecyl ammonium, methyl trihydrogenated tallow ammonium, methyl triricinoleyl ammonium, methyl tricoco ammonium, dibenzyl dicoco ammonium, dibenzyl dihydrogenated tallow ammonium, dibenzyl dioctadecyl ammonium, dibenzyl diricinoleyl ammonium, tribenzyl hydrogenated tallow ammonium, tribenzyl dioctadecyl ammonium, tribenzyl coco ammonium, tribenzyl ricinoleyl ammonium, and mixtures thereof.

In another specific embodiment herein, mixture (b) further comprises additional component selected from the non-limiting group consisting of proppant, which can be selected from the non-limiting group consisting of resin-coated sand and high-strength ceramic materials like sintered bauxite; wetting agent which can be selected from the non-limiting group consisting of lecithin and various surfactants such as the non-limiting group consisting of modified polyamide (solubilized in naphthenic oil) and alkylamidomine, and silicone surfactant(s) such as the non-limiting example of silicone surfactant (a) described herein; temperature stabilizing additive which can be selected from the non-limiting group consisting of ethylene glycol, propylene glycol, butylene glycol, hexylene glycol, glycerin, hexylene triol, ethanolamine, diethanolamine, triethanolamine, aminoethylethanol-amine, 2,3-diamino-1-propanol, 1,3-diamine-2-propanol, 3-amino-1,2-propanediol, 2-amino-1,3-propanediol; acrylic polymers; sulfonated polymers and copolymers; lignite; lignosulfonate; tannin-based additives; emulsifier which can be selected from the non-limiting group consisting of various fatty acid soaps, specifically the calcium soaps, and polyamides; alkalinity and pH control additives, which can be selected from the non-limiting group consisting of lime, caustic soda, soda ash and bicarbonate of soda, as well as other common acids and bases as are known to those skilled in the art; bactericides which can be selected from the non-limiting group consisting of imidazolines, aldehyde based formulations, such as paraformaldehyde, isothiazoline and brominated compounds such as are known to those skilled in the art; flocculants such as those which are used to increase viscosity for improved hole cleaning, to increase bentonite yield and to clarify or de-water low-solids fluids, which can be selected from the non-limiting group consisting of salt (or brine), hydrated lime, gypsum, soda ash, bicarbonate of soda, sodium tetraphosphate and acrylamide-based polymers; rheology modifier which can be selected from the non-limiting group consisting of starch, xanthan gum, dimeric and trimeric fatty acids, imidazolines, amides and synthetic polymers; filtrate reducers and/or fluid loss reducers which can be selected from the non-limiting group consisting of bentonite clays, lignite, sodium carboxymethylcellulose (CMC), and polyacrylate; shale control inhibitors which can be selected from the non-limiting group consisting of soluble calcium and potassium, as well as inorganic salts and organic compounds; lubricant which can be selected from the non-limiting group consisting of oil, synthetic liquid, graphite, surfactant, glycol and glycerin; and combinations thereof of any of the above described additional component. In one specific embodiment herein, additional component can be present in at least one of aqueous phase, solid filler phase and oil phase and/or in silicone surfactant (a) both prior to and/or after separation of mixture (b).

In one specific embodiment, wetting agent can be any wetting agent such as those described in the following U.S. patent Nos., incorporated herein by reference in their entireties: U.S. Pat. Nos. 2,612,471; 2,661,334; 2,943,051, and U.S. Patent Publication No. 2002/0055438 and wetting agent can further comprise silicone surfactant (a) as described herein.

In another specific embodiment herein, temperature stabilizing additive can contain from 2 to about 6 carbon atoms and from 2 to about 4 polar groups selected from the group consisting of hydroxyl (OH), primary amino (NH₂), and mixtures thereof, per molecule. In yet another specific embodiment, temperature stabilizing additive can be any temperature stabilizing additive such as those described in U.S. Pat. No. 4,508,628 the contents of which are incorporated by reference herein in its entirety.

In another specific embodiment emulsifier used in any mixture described herein, and specifically in preparing invert oil emulsion drilling fluids can be any of the commonly used water-in-oil emulsifiers used in the oil and gas drilling industry. The above-described emulsifier soaps can be formed in-situ in the oil-based mud by the addition of a desired fatty acid and a base, specifically the non-limiting example of lime. In one specific embodiment, some non-limiting representative emulsifiers are listed in the following U.S. patent Nos., incorporated herein by reference in their entireties: U.S. Pat. Nos. 2,861,042; 2,876,197; 2,994,660; 2,999,063; 2,962,881; 2,816,073, 2,793,996; 2,588,808; 3,244,638.

In a further specific embodiment, the fatty acid containing materials contain a fatty acid having eighteen carbon atoms, such as stearic acid, oleic acid, linoleic acid, preferably tall oil, air blown tall oil, oxidized tall oil, tryglycerides, and the like.

In yet another specific embodiment the polyamide emulsifiers result from the reaction of a polyalkylene polyamine, preferably a polyethylene polyamine, with from about 0.4 to about 0.7 equivalents of a mixture of fatty acids containing at least 50% by weight of a fatty acid having 18 carbon atoms, and with from about 0.3 to 0.6 equivalent of a dicarboxylic acid having from 4 to 8 carbon atoms. In another specific embodiment herein the polyamide emulsifiers that result from the reaction of a polyalkylene polyamine, with a mixture of fatty acids as described above can be those represented by the reaction equation described in U.S. Pat. No. 4,508,628, the contents of which are incorporated by reference herein in its entirety.

In another specific embodiment herein mixture (b) can comprise an oil phase. In another more specific embodiment oil phase can be any known or commercially and/or industrially used oil phase that is naturally present or is conventionally added through known and/or conventional methods. In one specific embodiment herein, oil phase can comprise a hydrocarbon. In another more specific embodiment oil phase can comprise petroleum oil fraction, natural or synthetic oil, fat, grease, wax, synthetic oil-containing silicone, grease-containing silicone, and combinations thereof. In yet another more specific embodiment herein, petroleum oil fraction is a natural or synthetic petroleum or petroleum product, selected from the group consisting of crude oil, heating oil, bunker oil, kerosene, diesel fuel, aviation fuel, gasoline, naphtha, shale oil, coal oil, tar-oil, lubricating oil, motor oil, mineral oil, ester oil, glyceride of fatty acid, aliphatic ester, aliphatic acetal, solvent, lubricating grease and combinations thereof. In one other specific embodiment herein oil phase of mixture (b) also contains additional silicone surfactant (a).

In one specific embodiment herein, the oil phase can also comprise other dissolved or suspended constituents, including suspended solid constituents which remain part of the oil phase after separation from another solid phase. In one specific embodiment for example, oil-based drilling fluid typically comprises a base oil, additives such as surfactants and viscosity modifiers, and suspended particles of clay such as described herein. In one specific embodiment, the clay imparts body to the fluid so that the circulating fluid can entrain drill cuttings and carry them from the borehole. In another specific embodiment, drilling fluids also frequently contain a finely divided weighting material such as barite, a dense mineral that increases the density of the fluid for use in deep wells. In another specific embodiment, both the clay and the weighting material are typically so finely divided that they can remain suspended in the base oil for a substantial length of time. In yet another specific embodiment, in the separation of drilling fluid from drill cuttings in accordance with this invention, the drilling fluid, including its suspended solid constituents, can constitute the “oil phase” and the drill cuttings can constitute the “solid filler phase.”

In yet another specific embodiment herein, whether a given particulate solid filler can be separated from an oil phase as described herein is believed to depend in part upon the affinity of the oil phase for the solid filler(s), that is, upon the tendency of the oil phase to wet the solid filler(s), and also in part upon the particle sizes of the solid filler, larger particles being easier to separate. In one specific embodiment, the base oil in drilling fluid has a relatively strong affinity for the clay particle(s), whereas shale oil has a lesser affinity for the siliceous ash particle(s) found in shale oil deasher sludge. In another specific embodiment herein, the clay, e.g., bentonite, particle(s) in drilling fluid are extremely fine, about 0.05 to 5 microns, averaging about 0.5 microns, whereas the ash particles in deasher sludge are on the order of 100 times larger, about 0.5 to 200 microns, averaging about 50 microns. In a more specific embodiment herein, clay particles are electrically charged and hence have a high affinity for oil phase, whereas siliceous particles are electrically neutral and hence have a lower affinity for oil phase. Thus, in one specific embodiment of this invention, clay particles in drilling fluid remain with the base oil when the fluid is separated from the drill cuttings, whereas in another embodiment, ash particles are separated from shale oil.

In yet another specific embodiment herein it is not possible to state in advance for all possible combinations of oils and particulate solids precisely which mixtures can be successfully separated in accordance with the embodiments described herein, but as a general rule, however, particles ranging in average size (greatest cross-sectional dimension) from about 50 microns and larger can be separated from hydrocarbonaceous oils, such as crude and refined petroleum oils and similar oils produced from oil shale, tar-oil sands, coal, and the like, without difficulty using the embodiments of composition described herein.

In yet another specific embodiment herein oil phase comprises specifically of from about 1 to about 90 weight percent, more specifically of from about 2 to about 70 weight percent and most specifically of from about 5 to about 50 weight percent of mixture (b) based on total weight of mixture (b) prior to separation of mixture (b). In yet another specific embodiment herein, oil phase that is substantially insoluble in said aqueous phase comprises an oil phase that is specifically less than about 10 volume percent soluble in said aqueous phase, more specifically less than about 5 volume percent soluble in said aqueous phase, and most specifically less than about 1 volume percent soluble in said aqueous phase, said volume percents being bases on the total volume of said oil phase.

The examples below are given for the purpose of illustrating the invention of the instant case. They are not being given for any purpose of setting limitations on the embodiments described herein.

### EXAMPLES

In one specific embodiment in this disclosure it will be understood that silicone surfactant (a) and demulsifier are equivalent terms. In another specific embodiment in this disclosure it will be understood that one or more silicone surfactant (a) and mixtures of different silicone surfactants (a) can be used as described in this disclosure. It will be understood herein that the phrases “% weight” and “weight percent” are interchangeable as described herein. It will be understood that time as expressed in the examples is always total time from beginning of the reaction mixture of polysiloxane hydride, the allyl ether (or allyl alcohol), 2-propanol (solvent, if present), buffer and catalyst. It will be understood herein that the terms/phrases “catalyst”, “platinum”, and “platinum catalyst” are used interchangeably herein. In one specific embodiment herein it will be understood that an initial catalyst charge is added at one time. If the reaction does not proceed to completion (i.e. consumption of all the silicanic hydrogen functionality) additional incremental charges of catalyst are made to drive the reaction to completion. In another specific embodiment herein it will be understood that Example A, B and C are organic demulsifiers that are reference points for comparing the benefits of the subject disclosure and the materials of Examples A, B and C themselves are formulations whose compositions are closely guarded trade secrets. The mud, which was studied in the examples below, (from a service company in oil and gas applications) is an oil based mud used for off shore drilling, taken out from the well after use, separated mechanically from its cuttings. It contains polymer coated organoclays, barium sulfate, biocides, emulsifiers, corrosion inhibitors, mineral oil, traces of crude oil from the well, water, inorganic salts, remaining cuttings. It will be understood herein in this entire disclosure that the use of the h and hours for time shall be deemed equivalent. The method of manufacture of the starting materials such as the non-limiting group of the polysiloxane hydrides is well known in the art as is described in U.S. Pat. Nos. 5,542,960; 6,221,815; 6,093,222; and 5,613,988, the contents of all of which are incorporated by reference herein in their entireties.

1. Phase Separation Test

A first qualitative screening test of organic, versus silicone based demulsifiers generally comprised of the composition described herein, was performed. For this, 50 grams (g) or (gms) of a used drilling mud (mud) in a glass flask was used, then the required amount of silicones (silicone surfactant (a)) as is described below (ranging from 0.1 weight percent to 5 weight percent for the largest concentration range (or from 0.05 g to 2.5 g of silicone in addition to 50g of mud with the weight percent of silicone based on total weight of mud), was added to the mud). The glass flask was then shaken by hand vigorously for a period of 10 seconds timed with a stop watch and the sample was allowed to settle for an unspecific period of time but for a minimum of one day prior to screening. Generally the qualitative observation of phase separation over time was done in the first 150 minutes where most of the phase separation occurred, this was a rough test that was qualitatively determined. If a big phase separation of from 40 to 50 volume percent of aqueous phase compared to the whole sample volume of mud and silicone occurred, it was noted by the term “YES” in Table 1, if a small phase separation of about 10 volume percent occurred it was noted by “SLIGHT” in Table 1 and when no phase separation occurred it was noted by “NO” in Table 1.

2. Rate of Phase Separation—Turbiscan Lab instrument

The heart of Turbiscan Lab instrument from Formulation is a detection head which moves up and down along a flat bottomed borosilicate glass cylindrical cell. The detection head is composed of a pulsed near infrared light (λ=850 nm) and two synchronous detectors. The transmission detector receives the light, which goes through the sample (0° from the incident beam) while the backscattering detector receives the light scattered by the sample at 135° from the incident beam. (The angle of 135° was chosen so as to be outside of the coherent backscattering cone). The detection head scans the entire length of the sample (about 45 mm) acquiring transmission and backscattering data every 40 μm (1625 transmission and backscattering acquisition per scan). These measured fluxes are calibrated with a non-absorbing reflectance standard (calibrated polystyrene latex beads) and a transmittance standard (silicon oil). The signal is first treated by a Turbiscan Lab current to voltage converter. The integrated microprocessor software handles data acquisition, analogue to digital conversion, data storage, motor control and computer dialogue.

Description of the Turbiscan Plots:

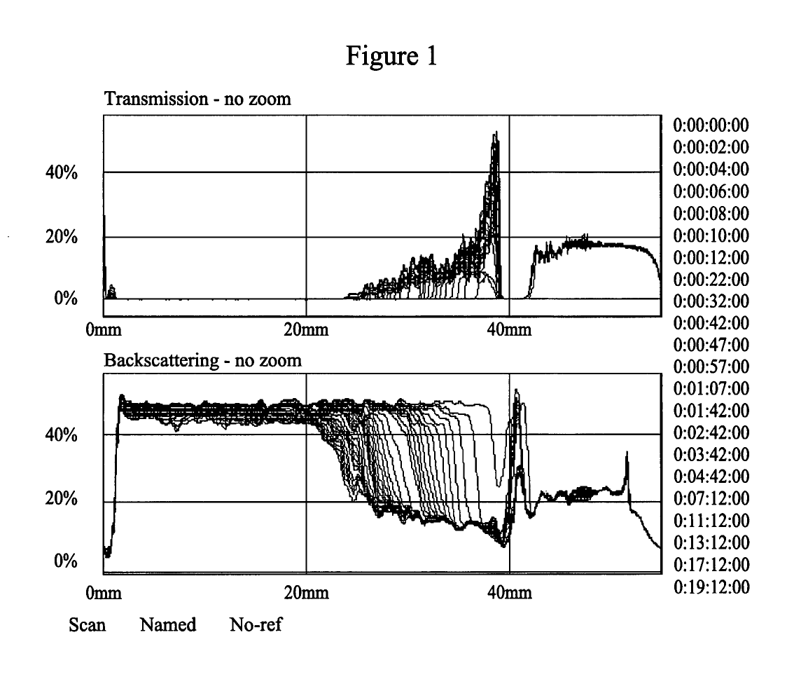

Silicone surfactant (a) was added on the top of a drilling mud (% weight silicone surfactant (a)/weight of mud, the mud weight being 50g in a glass flask which was shaken vigorously by hand for 10 seconds (timed using wrist watch) and then poured into the borosilicate glass used for the Turbiscan Lab instrument. The scans were started as soon as possible after preparation to see the settlement of the sediments. The scans were taken every minute for 10 minutes and then every 5 minutes for the following 50 minutes, and then every 30 min for the following 3 hours and 30 minutes and finally every 2 hours for the following 18 hours). FIG. 1 shows a plot obtained by the Turbiscan Lab instrument from the beginning of demulsification using silicone surfactant (a) and for a period of 22 hours following the beginning of demulsification. The vertical axis describes the diffuse reflectance or back scattering normalized with respect to a non absorbing standard reflector and the horizontal axis represents the sample height in millimeters (mm) (0 mm corresponds to the measurement cell bottom).

Due to the action of the silicone surfactant (a) on the mud, there is a sedimentation of the heavy solid particles (barite and clays) occurring quickly shown on the backscattering plot by the shift of the sharp decrease on the right hand side of each curve to the left (corresponding to the descent of the interface between the upper aqueous phase and the solid filler phase). It is interesting to notice that Turbiscan Lab instrument allows the detection of the destabilization of the drilling mud at an early stage even though the medium is not transmitting light.

FIG. 1: Transmission and back scattering data from the Turbiscan Lab instrument at 29 degrees Celsius (° C.) for a drilling mud from the Service Company treated with 2 weight % of Example 10B (Y-17014) based on the weight of the drilling mud sample (corresponding to 1 g of silicone with 50 g of mud).

[image]

Analysis of the data: the position of the interface air/drilling mud at the beginning of the demulsification using silicone surfactant (a) gives us the total height of the drilling mud in the Turbiscan tube and it is given by the right hand side of the first transmission curve when the curve meets the zero transmission axis. The bottom (minimum height of the drilling mud in the tube) of the Turbiscan glass is given by the left hand side of the first curve when the curve leaves the zero transmission axis. The evolution of the demulsification of the drilling mud using silicone surfactant (a) is indicated by the decrease of the position of the aqueous phase/solid filler phase interface with time. This position is given by the inflexion point of the sharpest decrease in back scattering and shifting to the left (the height of the solid filler phase is then decreasing with time). The aqueous phase is then deduced from the complement to this position compared to the whole sample. (See Tables 2a, 2b and 2c for different concentrations of demulsifiers ranging from 2 to 0.5% weight percent of demulsifier based on the total weight of the mud)

The same experiments were preformed for the different silicone surfactants (a) and then the results were compared to three other organic demulsifiers provided by a Service Company which is a customer.

Example A belongs to the family of ethoxylated alcohol and Example B, belongs to the family of glycosides, Example C is a trade secret compound that is unknown and was provided as a reference under a secrecy agreement thus preventing applicants from investigating or divulging its description. We compared the results in terms of percentages of the position of the solid filler phase/aqueous phase interface. In conclusion, from Tables 2a, 2b and 2c, the largest and fastest aqueous phase separation was obtained for Example 41 (Y-17015) in the first 400 minutes (min). As described above Examples A, B and C are reference points for comparing the benefits of the subject disclosure and the materials of Examples A, B, and C themselves are formulations whose compositions are closely guarded trade secrets.

3. Water Clarity—Hach 2100 Ratio Turbidity Measurement

The best estimation of the clarity of the aqueous phase after separation was to use the Hach 2100 NTU turbidimeter (NTU=nephelometric turbidity units) because the demulsification of drilling mud by silicone surfactant (a) or organics lead to the sticking of drilling mud sediments on the wall of the glass flask. So the aqueous phase had to be taken out without contaminating it to measure its turbidity. 250 g of drilling mud was treated with demulsifier at the required amount. The mixture was shaken by hand vigorously for 10 seconds and left to settle for two specified time like 6 hours and 12 hours. Around 30g of the aqueous top layer was removed with a plastic pipette in the middle of the aqueous phase (to avoid the taking of the surface of the water and sediments at the bottom of the aqueous phase) at different times. The turbidity of water taken out was measured. (see Table 4) Turbidity measures the scattering of light through water caused by materials in suspension or solution. The suspended and dissolved material can include clay, silt, finely divided organic and inorganic matter, soluble coloured organic compounds, and plankton and other microscopic organisms.

Other methods used for analysis of the drilling mud:

(a) Measurement of the non volatile content of the drilling mud or different phases after phase separation: The test was performed on 2 gram samples (either the drilling mud alone or the separated aqueous phase or the separated solid filler phase) by using a thermogravimetric balance and heating the sample up to about 160° C. The evolution of the disappearance of the volatile compounds was observed by measuring the lost of weights from 100 weight percent to 0 weight percent based on the total weight of volatile compound(s). The remaining non-volatiles compound(s) corresponded to the remaining weight on the aluminium plate. The obtained percentages corresponded to the ratio of the remaining weight after heating, to the initial mass of 2 grams. (See Table 3a for the results).

(b) Analysis of the water content in the solid filler phase (sediments, barite) after phase separation (and also for the drilling mud alone) and after the aqueous phase was discarded was performed using the Karl Fischer method. For this test, each sample was homogenized by shaking. Around 10 g of sample was taken in 50 ml of Isopropyl alcohol (IPA) in polypropylene container. The sample solution in IPA was shaken well to extract water from the mud. (See Table 3b for the results.) The titration of Silicon content by aluminum molybdate was performed according to the ASTM method D859-00 (Standard test method for silica in water) in the water phases separated after treating the mud with 2% w/w demulsifiers (separated water taken out after 6 or 12 hours). We had to measure the silicon content in the aqueous phase to see where the silicon is remaining; for environmental reasons in case of discharge of the water separated into the sea or on the ground. (see Table 3c) The presence of heavy metals was also measured in the separated aqueous phase (both after 6 hours and 12 hours (total time after the shaking of mud treated with 2% w/w of demulsifier (or 1 g on top of 50 g mud))) using an Inductively Coupled Plasma (ICP) Atomic Emission Spectrometer. (description of the method: 5 g of water layer weighed in a beaker, were slowly evaporated to dryness at 50 deg C. The residue obtained was boiled with concentrated nitric acid to leach out possible heavy metals in the residue. The solution was made up to 25 ml using Milli-Q water, and analyzed by ICP) (see Table 3d).

TABLE 1
Summary of materials tested (with results for phase separation test 1)
The products listed in Table 1 in the second column starting from and
including from Silwet L-720 and including all the products down the second
column up to and including Y-17015 are commercially available from GE
Silicone with the exception of Magnasoft Expend, TP-360 and TP 3890which
are no longer commercial grades. The remaining products in Table 1 and
the continuation of Table 1 below are described herein.

| | | | | Level tested |
|---|---|---|---|---|
| | | | Demulsification | (weight percent |
| | | | (phase | as weight of |
| | | Sili- | separation | demulsifier/ |
| Example | Product | cone | test 1) | weight of the mud) |
| | Silwet L-720 | Yes | Slight | 1% |
| | Silwet L-7200 | Yes | No | 1% |
| | Silwet L-7230 | Yes | No | 1% |
| Ex 66 | Silwet L-7280 | Yes | Yes | 1 to 3% |
| | Silwet L-7550 | Yes | No | 1% |
| | Silwet L-7600 | Yes | No | 1% |
| | Silwet L-7602 | Yes | No | 1% |
| | Silwet L-7604 | Yes | No | 1% |
| Ex 67 | Silwet L-7607 | Yes | No | 1 to 5% |
| | Silwet L-7650 | Yes | No | 1% |
| Ex 28 | Silwet L-77 | Yes | Yes | 1.5 to 3% |
| | Silwet L-8600 | Yes | No | 1% |
| | Silwet L-8610 | Yes | No | 1% |
| | Magnasoft | Yes | | |
| | Expend | | No | 1% |
| | Magnasoft | Yes | | |
| | HSSD | | No | 1% |
| | Magnasoft SRS | Yes | No | 1% |
| | Magnasoft HWS | Yes | Slight | 1% |
| | Magnasoft Ultra | Yes | No | 1% |
| | Silbreak 1324 | Yes | No | 1% |
| | Silbreak 1840 | Yes | No | 1% |
| | Silbreak 327 | Yes | No | 1% |
| | Silbreak 605 | Yes | Slight | 1% |
| | Silbreak 625 | Yes | Slight | 1% |
| | Silbreak 322 | Yes | No | 1% |
| | Silbreak 323 | Yes | Slight | 1% |
| | Silbreak 638 | Yes | No | 1% |
| | Silquest PA-1 | Yes | No | 1% |
| | TP 360 | Yes | No | 2% |
| | TP-367 | Yes | No | 1% |
| | TP 3890 | Yes | No | 1% |
| Ex 68 | Y-14759 | Yes | No | 1% |
| | Y-14547 | Yes | Slight | 1% |
| Ex 10B | Y-17014 | Yes | Yes | 0.2% to 2% |
| Ex 41 | Y-17015 | Yes | Yes | 0.5 to 2% |
| | Y-17191 | Yes | Yes | 0.5 to 2% |
| Ex 69 | Y-17188 | Yes | Yes | 1% |
| Ex 70 | Y-17189 | Yes | Yes | 1% |
| Ex 71 | Y-17190 | Yes | Yes | 1% |
| Ex A | Demulsifier B | No | Yes | 0.5 to 2% |
| Ex B | Demulsifier C | No | Yes | 0.75 to 2% |
| Ex C | Demulsifier A | No | No | 2% |
| Ex 01 | MF V | Yes | No | 1% |
| Ex 02 | MF VI | Yes | No | 1% |
| Ex 03 | MF VII | Yes | No | 1% |
| Ex 04 | MF VIII | Yes | No | 1% |
| Ex 05 | MF IX | Yes | No | 1% |
| Ex 06 | MF X | Yes | No | 1% |
| Ex 07 | MF XI | Yes | No | 1% |
| Ex 08 | MF XII | Yes | No | 1% |
| Ex 09 | MF XIII | Yes | No | 1% |
| Ex 10A | MF XIV | Yes | Yes | 1% |
| Ex 11 | MF XV | Yes | Yes | 1% |
| Ex 12 | MF XVI | Yes | Yes | 1% |
| Ex 13 | MF XVII | Yes | Yes | 0.3 to 2% |
| Ex 14 | RH I | Yes | No | 1% |
| Ex 15 | RH II | Yes | No | 1% |
| Ex 16 | RH III | Yes | No | 1% |
| Ex 17 | RH V | Yes | No | 1% |
| Ex 18 | RH VI | Yes | No | 1% |
| Ex 19 | RH VII | Yes | No | 1% |
| Ex 20 | RH VIII | Yes | No | 1% |
| Ex 21 | RH IX | Yes | No | 1-2% |
| Ex 22 | RH X | Yes | No | 1-2% |
| Ex 23 | RH XI | Yes | No | 1% |
| Ex 24 | RH XII | Yes | No | 1% |
| Ex 25 | RH XIII | Yes | No | 1% |
| Ex 26 | RH XIV | Yes | Yes | 1% |
| Ex 27 | RH XV | Yes | No | 1% |
| Ex 29 | RH XVII | Yes | No | 1% |
| Ex 30 | RH XVIII | Yes | No | 1% |
| Ex 31 | RH XIX | Yes | No | 1% |
| Ex 32 | RH XX | Yes | No | 1% |
| Ex 33 | RH XXI | Yes | No | 1% |
| Ex 34 | RH XXII | Yes | No | 1% |
| Ex 35 | RH XXIII | Yes | Slight | 1% |
| Ex 36 | RH XXIV | Yes | Slight | 1% |
| Ex 37 | RH XXV | Yes | No | 1% |
| Ex 38 | RH XXVI | Yes | No | 1% |
| Ex 39 | RH XXVII | Yes | No | 1% |
| Ex 40 | RH XXVIII | Yes | No | 1% |
| Ex 42 | WARO 2590 | Yes | No | 1% |
| Ex 43 | WARO 2591 | Yes | Yes | 0.5 to 2% |
| Ex 44 | WARO 2592 | Yes | No | 1% |
| Ex 45 | WARO 2593 | Yes | No | 1% |
| Ex 46 | WARO 2594 | Yes | No | 1% |
| Ex 47 | WARO 2595 | Yes | No | 1% |
| Ex 48 | WARO 2596 | Yes | No | 1% |
| Ex 49 | WARO 2597 | Yes | No | 1% |
| Ex 50 | WARO 3609 | Yes | No | 1% |
| Ex 51 | WARO 3743 | Yes | No | 1% |
| Ex 52 | WARO 3744 | Yes | No | 1% |
| Ex 53 | WARO 3745 | Yes | No | 1% |
| Ex 54 | WARO 2598 | Yes | No | 1% |
| Ex 55 | WARO 2599 | Yes | Yes | 0.5 to 2% |
| Ex 56 | WARO 3601-2 | Yes | Yes | 0.5 to 2% |
| Ex 57 | WARO 3602 | Yes | No | 1% |
| Ex 58 | WARO 3603 | Yes | No | 1% |
| Ex 59 | WARO 3604 | Yes | No | 1% |
| Ex 60 | WARO 3605 | Yes | No | 1% |
| Ex 61 | WARO 3606 | Yes | No | 1% |
| Ex 62 | WARO 3610 | Yes | No | 1% |
| Ex 63 | WARO 3748 | Yes | No | 1% |
| Ex 64 | WARO 3749 | Yes | No | 1% |
| Ex 65 | WARO 3751 | Yes | No | 1% |

In one specific embodiment, we define for the following examples the following definitions:

M=Si(CH₃)₃—O_{1/2}

M^{H}=SiH(CH₃)₂—O_{1/2}

D^{H}=SiH(CH₃)(O_{1/2})₂

D=Si(CH₃)₂(O_{1/2})₂

MM=hexamethyldisiloxane

M^{H}M^{H}=1,1,3,3-Tetramethyldisiloxane

D4=octamethylcyclotetrasiloxane

L31=MD₅₀^{H}M

MDₓ^{H}M or M^{H}DₓM^{H} are also called SiH or polysiloxane hydride

The catalyst is either a 3.3 weight percent (wt %) (based on the weight of ethanol) solution of chloroplatinic acid in ethanol or a Karstedt PTS type catalyst solution of (“Platinum chelated to tetravinyl cyclotetrasiloxane”) in toluene containing 1 wt % platinum metal (based on the weight of toluene) The Karstedt PTS type catalyst is a commercially available at ABCR as Platinum-cyclovinylmethylsiloxane complex in cyclic methylvinyls with the CAS number 68585-32-0. The allyl content (or vinyl content or unsaturation rate) of a molecule is the ratio in weight percent between the molecular weight of the allyl (or vinyl) group and the molecular weight of the total molecule. It will be understood herein that demulsifier and silicone surfactant(a), as described herein, are interchangeable. A 30% molar excess of the allyl ether corresponds to an excess of 30% of the allyl ether in moles compared to the polysiloxane hydride as described in each example below. M^{H}M^{H} is commercially available from Fluka (CAS N°=3277-26-7) as 1,1,3,3-Tetramethyldisiloxane. For the paragraphs 136 to 158, it is noted in various examples below that NMR spectra indicated that the reaction product could be at times either Si—C linked (between the polysiloxane hydride and the ally ether) or the Si—O—C linked. The type of reaction product was then indicated.

Example 01 (MF V) is a laboratory prepared material obtained from the hydrosilylation reaction between M^{H}D₈ M^{H} and a 30% molar excess of trimethylolpropane monoallyl ether which has the formula of CH₂═CH—CH₂—O—CH₂—C(CH₂OH)₂—C₂H₅. A nitrogen blanketed glass reactor at atmospheric pressure, which was equipped with a temperature probe, an agitator, a condenser and a nitrogen inlet, was charged with 30 gms of polysiloxane hydride of the formula equilibrate M^{H}D₈ M^{H} containing 61.7 cubic centimeters per gram (cc/g) of active hydrogen (cCH₂/g), 18 gms of the allyl ether with an allyl content of 23.3 weight percent and 48.9 gms of 2-propanol (solvent); then 114 microliters of dibutylethanolamine was added as a buffer. The reaction mixture (heterogeneous) was heated to 74° C. and platinum catalyst was introduced as 98 microliters of a 3.3% solution of chloroplatinic acid in ethanol (based on the weight of ethanol), corresponding to 10 parts per million (ppm) of platinum (platinum metal). The reaction was exothermic and the reactor temperature rose to 85° C. within 9 minutes. The reaction was complete (i.e., the equilibrate SiH (M^{H}D₈ M^{H}) was consumed) after 1 hour (total time). The copolymer was allowed to cool with stirring in the reactor for 30 minutes and then removed. The solvent was stripped out under vacuum. The equilibrate M^{H}D₈ M^{H} was obtained by adding 36.9 g of M^{H}M^{H}, where M^{H} has the definition described above, 163.1 g of D₄ with 163 microliters of trimethylsilyl trifluoromethanesulfonate. The glass flask was put on a rolling shaker for 24 hours to equilibrate and the following day dibutylethanolamine (272 microliters) was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a folded filter paper (10 μm pore size).

Example 02 (MF VI) is a laboratory prepared material obtained from the hydrosilylation reaction between the equilibrate M^{H}D₈ M^{H} and a 30% molar excess of an allyl started polyether of the formula CH₂═CH—CH₂—O—(CH₂CH₂O)₁₂H. A nitrogen blanketed glass reactor at atmospheric pressure, which was equipped with a temperature probe, an agitator, a condenser and a nitrogen inlet, was charged with 30 gms of polysiloxane hydride of the formula equilibrate M^{H}D₈M^{H} containing 61.7 cc/g of active hydrogen, 60.4 gms of the allyl ether with an allyl content of 7.3 weight percent (ratio between the molecular weight of the allyl group and the molecular weight of the total molecule) and 90.4 gms of 2-propanol; then 181 microliters of dibutylethanolamine was added as a buffer. The reaction mixture (heterogeneous) was heated to 73° C. and platinum catalyst was introduced as 212 microliters of a 3.3% solution of chloroplatinic acid in ethanol, corresponding to 10 ppm of platinum. The reaction was exothermic and the reactor temperature rose to 79° C. within 15 minutes. The reaction was complete (i.e., the equilibrate SiH was consumed) after 1 hour (total time). The copolymer was allowed to cool in the reactor for 30 minutes and then removed. The solvent was stripped out under vacuum. The equilibrate M^{H}D₈ M^{H} was obtained as explained in example 01.

Example 03 (MF VII) is a laboratory prepared material obtained from the hydrosilylation reaction between the equilibrate M^{H}D₆ M^{H} and a 30% molar excess of an allyl started polyether of the formula CH₂═CH—CH₂—O—(CH₂CH₂O)₁₂H. A nitrogen blanketed glass reactor at atmospheric pressure, which was equipped with a temperature probe, an agitator, a condenser and a nitrogen inlet, was charged with 30 gms of polysiloxane hydride of the formula equilibrate M^{H}D₆ M^{H} containing 77.5 cc/g of active hydrogen, 75.8 gms of the allyl ether with an allyl content of 7.3 weight percent, and 105.8 gms of 2-propanol; then 246 microliters of dibutylethanolamine were added as a buffer. The reaction mixture (heterogeneous) was heated to 73° C. and platinum catalyst was introduced as 212 microliters of a 3.3% solution of chloroplatinic acid in ethanol (based on the weight of ethanol), corresponding to 10 parts per million (ppm) of platinum. The reaction was exothermic and the reactor temperature slightly rose to 79° C. within 40 minutes. The reaction was complete (i.e., the equilibrate SiH was consumed) after 1 hour (total time). The copolymer was allowed to cool in the reactor for 30 minutes and then removed. The solvent was stripped out under vacuum. The equilibrate M^{H}D₆M^{H} was obtained by adding 46.4 g of M^{H}M^{H}, 153.6 g of D₄ with 163 microliters of trimethylsilyl trifluoromethanesulfonate. The glass flask was put on a rolling shaker for 24 hours to equilibrate and the next day 272 microliters of dibutylethanolamine was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a folded filter paper.

Example 04 (MF VIII) is a laboratory prepared material obtained from the hydrosilylation reaction between the equilibrate M^{H}D₄M^{H} and a 30% molar excess of an allyl started polyether of the formula CH₂═CH—CH₂—O—(CH₂CH₂O)₁₂H. A nitrogen blanketed glass reactor at atmospheric pressure, which was equipped with a temperature probe, an agitator, a condenser and a nitrogen inlet, was charged with 25 gms of polysiloxane hydride of the formula equilibrate M^{H}D₄ M^{H} containing 104.1 cc/g of active hydrogen, 85 gms of the allyl ether with an allyl content of 7.3 weight percent, and 110 gms of 2-propanol; then 256 microliters of dibutylethanolamine was added as a buffer. The reaction mixture (heterogeneous) was heated to 73° C. and platinum catalyst was introduced as 220 microliters of a 3.3% solution of chloroplatinic acid in ethanol, corresponding to 10 parts per million (ppm) of platinum. The reaction was exothermic and the reactor temperature rose to 79° C. within 40 minutes. The reaction was complete (i.e., the equilibrate SiH was consumed) after 1 hour (total time). The copolymer was allowed to cool in the reactor for 30 minutes and then removed. The solvent was stripped out under vacuum. The equilibrate M^{H}D₄ M^{H} was obtained by adding 62.3 g of M^{H}M^{H}, 137.7 g of D₄ with 163 microliters of trimethylsilyl trifluoromethanesulfonate. The glass flask was put on a rolling shaker for 24 hours to equilibrate and the next day 272 microliters of dibutylethanolamine was added for neutralization. The mixture was shaken on the rollers for 1 hour. There were some droplets on the walls of the glass so 3 spatulas of NaHCO₃ were added to further neutralize the mixture and then the mixture was filtered on a folded filter paper.

Example 05 (MF IX) is a laboratory prepared material obtained from the hydrosilylation reaction between the equilibrate M^{H}D₂ M^{H} and a 30% molar of an allyl started polyether of the formula CH₂═CH—CH₂—O—(CH₂CH₂O)₁₂H. A nitrogen blanketed glass reactor at atmospheric pressure, which was equipped with a temperature probe, an agitator, a condenser and a nitrogen inlet, was charged with 16 gms of polysiloxane hydride of the formula equilibrate M^{H}D₂ M^{H} containing 158.8 cc/g of active hydrogen, 82.9 gms of the allyl ether with an allyl content of 7.3 weight percent, and 98.9 gms of 2-propanol; then 230 microliters of dibutylethanolamine was added as a buffer. The reaction mixture (heterogeneous) was heated to 73° C. and platinum catalyst was introduced as 198 microliters of a 3.3% solution of chloroplatinic acid in ethanol, corresponding to 10 ppm of platinum. The reaction was slightly exothermic and the reactor temperature rose to 75° C.; then a second addition of platinum (10 ppm) was done at 40 minutes (total time). The reaction was complete (i.e., the equilibrate SiH was consumed) after 3 hours. The copolymer was allowed to cool in the reactor for 30 minutes and then removed. The solvent was stripped out under vacuum. The equilibrate M^{H}D₂M^{H} was obtained by adding 95 g of M^{H}M^{H}, 105g of D₄ with 163 microliters of trimethylsilyl trifluoromethanesulfonate. The glass flask was put on a rolling shaker for 24 hours to equilibrate and the next day 272 microliters of dibutylethanolamine were added for neutralization. The mixture was shaken on the rollers for 1 hour. There were some droplets on the walls of the glass so 3 spatulas of NaHCO₃ were added to further neutralize the mixture and then the mixture was filtered on a paper filter.

Example 06 (MF X) is a laboratory prepared material obtained from the hydrosilylation reaction between the equilibrate M^{H}D₆M^{H} and a 30% molar excess of an allyl started polyether of the formula CH₂═CH—CH₂—O—(CH₂CH₂O)_{7.5}H. A nitrogen blanketed glass reactor at atmospheric pressure, which was equipped with a temperature probe, an agitator, a condenser and a nitrogen inlet, was charged with 42 gms of polysiloxane hydride of the formula equilibrate M^{H}D₆M^{H} containing 77.5 cc/g of active hydrogen, 75.9 gms of the allyl ether with an allyl content of 10.23 weight percent; then 137 microliters of dibutylethanolamine was added as a buffer. The reaction mixture (heterogeneous) was heated to 73° C. and platinum catalyst was introduced as 118 microliters of a 3.3% solution of chloroplatinic acid in ethanol, corresponding to 10 ppm of platinum. The reaction was exothermic and the reactor temperature rose to 96° C. within 25 minutes. The reaction was complete (i.e., the equilibrate SiH was consumed) after 1 hour. The copolymer was allowed to cool in the reactor for 30 minutes and then removed. The equilibrate M^{H}D₆M^{H} was obtained as quoted in example 03.

Example 07 (MF XI) is a laboratory prepared material obtained from the hydrosilylation reaction between the equilibrate M^{H}D₄M^{H} and a 30% molar excess of an allyl started polyether of the formula CH₂═CH—CH₂—O—(CH₂CH₂O)_{7.5}H. A nitrogen blanketed glass reactor at atmospheric pressure, which was equipped with a temperature probe, an agitator, a condenser and a nitrogen inlet, was charged with 34 gms of polysiloxane hydride of the formula equilibrate M^{H}D₄M^{H} containing 104.1 cc/g of active hydrogen, 82.6 gms of the allyl ether with an allyl content of 10.2 weight percent; then 136 microliters of dibutylethanolamine was added as a buffer. The reaction mixture (heterogeneous) was heated to 73° C. and platinum catalyst was introduced as 117 microliters of a 3.3% solution of chloroplatinic acid in ethanol, corresponding to 10 ppm of platinum. The reaction was exothermic and the reactor temperature rose to 88° C. within 49 minutes. The reaction was complete (i.e., the equilibrate SiH was consumed) after 3 hours. The copolymer was allowed to cool in the reactor for 30 minutes and then removed. The equilibrate M^{H}D₄M^{H} was obtained as quoted in example 04.

Example 08 (MF XII) is a laboratory prepared material obtained from the hydrosilylation reaction between the equilibrate M^{H}D₂M^{H} and a 30% molar excess of an allyl started polyether of the formula CH₂═CH—CH₂—O—(CH₂CH₂O)_{7.5}H. A nitrogen blanketed glass reactor at atmospheric pressure, which was equipped with a temperature probe, an agitator, a condenser and a nitrogen inlet, was charged with 25 gms of polysiloxane hydride of the formula equilibrate M^{H}D₂M^{H} containing 158.8 cc/g of active hydrogen, 92.6 gms of the allyl ether with an allyl content of 10.2 weight percent; then 137 microliters of dibutylethanolamine was added as a buffer. The reaction mixture (heterogeneous) was heated to 73° C. and platinum catalyst was introduced as 116 microliters of a 3.3% solution of chloroplatinic acid in ethanol, corresponding to 10 ppm of platinum. After no increase of temperature, a second addition of catalyst (10 ppm) was done at 17 min (total time) and 74° C. and a third addition of catalyst of 10 ppm was done at 60 min (total time) at 74° C. Then the temperature rose up to 85° C. after 107 minutes (total time). The reaction was complete (i.e., the equilibrate SiH was consumed) after 4 hours (total time). The copolymer was allowed to cool in the reactor for 30 minutes and then removed. The equilibrate M^{H}D₂M^{H} was obtained as quoted in example 05.

Example 09 (MF XIII) is a laboratory prepared material obtained from the hydrosilylation reaction between the equilibrate M^{H}D₆M^{H} and a 30% molar excess of an allyl started polyether of the formula CH₂═CH—CH₂—O—(CH₂CH₂O)_{3.5}H. A nitrogen blanketed glass reactor at atmospheric pressure, which was equipped with a temperature probe, an agitator, a condenser and a nitrogen inlet, was charged with 33 gms of polysiloxane hydride of the formula equilibrate M^{H}D₆M^{H} containing 77.5 cc/g of active hydrogen, 32.1 gms of the allyl ether with an allyl content of 19.0 weight percent; then 76 microliters of dibutylethanolamine was added as a buffer. The reaction mixture (heterogeneous) was heated to 73° C. and platinum catalyst was introduced as 65 microliters of a 3.3% solution of chloroplatinic acid in ethanol, corresponding to 10 ppm of platinum. The reaction was exothermic and the reactor temperature rose to 116° C. within 5 minutes. The reaction was complete (i.e., the equilibrate SiH was consumed) after 1 hour. The copolymer was allowed to cool in the reactor for 30 minutes and then removed. The equilibrate M^{H}D₆M^{H} was obtained as quoted in example 03.

Example 10A (MF XIV) is a laboratory prepared material obtained from the hydrosilylation reaction between the equilibrate M^{H}D₄M^{H} and a 30% molar excess of an allyl started polyether of the formula CH₂═CH—CH₂—O—(CH₂CH₂O)_{3.5}H. A nitrogen blanketed glass reactor at atmospheric pressure, which was equipped with a temperature probe, an agitator, a condenser and a nitrogen inlet, was charged with 33 gms of polysiloxane hydride of the formula equilibrate M^{H}D₄M^{H} containing 104.1 cc/g of active hydrogen, 43.1 gms of the allyl ether with an allyl content of 19.0 weight percent; then 89 microliters of dibutylethanolamine was added as a buffer. The reaction mixture (heterogeneous) was heated to 73° C. and platinum catalyst was introduced as 76 microliters of a 3.3% solution of chloroplatinic acid in ethanol, corresponding to 10 ppm of platinum. The reaction was exothermic and the reactor temperature rose to 124° C. within 9 minutes (total time). The reaction was complete (i.e., the equilibrate SiH was consumed) after 1 hour. The equilibrate M^{H}D₄M^{H} was obtained as quoted in example 04.

Example 10B (Y-17014) is a commercial product from GE Silicones.

Example 11 (MF XV) is a laboratory prepared material obtained from the hydrosilylation reaction between the equilibrate M^{H}D₂M^{H} and a 30% molar excess of an allyl started polyether of the formula CH₂═CH—CH₂—O—(CH₂CH₂O)_{3.5}H. A nitrogen blanketed glass reactor at atmospheric pressure, which was equipped with a temperature probe, an agitator, a condenser and a nitrogen inlet, was charged with 33 gms of polysiloxane hydride of the formula equilibrate M^{H}D₂M^{H} containing 158.8 cc/g of active hydrogen, 65.75 gms of the allyl ether with an allyl content of 19.0 weight percent; then 115 microliters of dibutylethanolamine was added as a buffer. The reaction mixture (heterogeneous) was heated to 73° C. and platinum catalyst was introduced as 99 microliters of a 3.3% solution of chloroplatinic acid in ethanol, corresponding to 10 ppm of platinum. After no increase of temperature, a second addition of catalyst (10 ppm) was done (after 27 min, total time) and then the temperature rose up to 118° C. after 51 minutes (total time). The reaction was complete (i.e., the equilibrate SiH was consumed) after 2 hours. The copolymer was allowed to cool in the reactor for 30 minutes and then removed. The equilibrate M^{H}D₂M^{H} was obtained as quoted in example 05.

Example 12 (MF XVI) is the reaction product of the hydrosilylation between the equilibrate MDD^{H}M and a 30% molar excess of an allyl started polyether with the formula of CH₂═CH—CH₂—O—(CH₂CH₂O)_{3.5}H. A nitrogen blanketed glass reactor at atmospheric pressure, which was equipped with a temperature probe, an agitator, a condenser and a nitrogen inlet, was charged with 80.5 gms of polysiloxane hydride of the formula equilibrate MDD^{H}M containing 72.9 cc/g of active hydrogen, 73.6 gms of polyether with an allyl content of 18.96 weight percent and 179 microliters of dibutylethanolamine as a buffer. The reaction mixture (heterogeneous) was heated to 74° C. and platinum catalyst was introduced as 154 microliters of a 3.3% solution of chloroplatinic acid in ethanol, corresponding to 10 parts per million (ppm) of platinum. The reaction was exothermic and the reactor temperature rose to 122° C. within 12 minutes (total time). The reaction was complete (i.e., the equilibrate SiH was consumed) after 1 hour. The copolymer was allowed to cool in the reactor for 30 minutes and then removed. The equilibrate MDD^{H}M was obtained by adding 106.4 g of MM, 49.9 g of D₄ and 43.6 g of MD₅₀^{H}M or L31 (for the D^{H} units) with 163 microliters of trimethylsilyl trifluoromethanesulfonate. The glass flask was put on a rolling shaker for 24 hours to equilibrate and the next day 272 microliters of dibutylethanolamine was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a folded filter paper.

Example 13 (MF XVII) is the reaction product of the hydrosilylation between the equilibrate M(D^{H})₂M and a 30% molar excess of an allyl started polyether with the formula of CH₂═CHCH₂—O—(CH₂CH₂O)_{3.5}—H. A nitrogen blanketed glass reactor at atmospheric pressure, which was equipped with a temperature probe, an agitator, a condenser and a nitrogen inlet, was charged with 30.0 gms of polysiloxane hydride of the formula equilibrate M(D^{H})₂M containing 153 cc/g of active hydrogen, 57.60 g of the polyether with an allyl content of 18.96 weight percent and 102 microliters of dibutylethanolamine as a buffer. The reaction mixture (heterogeneous) was heated to 72° C. and platinum catalyst was introduced as 88 microliters of a 3.3% solution of chloroplatinic acid in ethanol, corresponding to 10 ppm of platinum. The reaction was exothermic and the reactor temperature rose to 99° C. within 40 minutes. The reaction was complete (i.e., the equilibrate SiH was consumed) after 2 hours. The copolymer was allowed to cool in the reactor for 30 minutes and then removed. The equilibrate M(D^{H})₂M was obtained by adding 108.4 g of MM and 91.6 g of MD₅₀^{H}M (or L31) with 163 microliters of trimethylsilyl trifluoromethanesulfonate. The glass flask was put on a rolling shaker for 24 hours to equilibrate and the next day 272 microliters of dibutylethanolamine was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a folded filter paper.

Example 14 (RH I) is a laboratory prepared material obtained from the hydrosilylation reaction between the equilibrate M^{H}D₁₀M^{H} and a 30% molar excess of an allyl started polyether CH₂═CH—CH₂—O—(CH₂CH₂O)_{7.5}H. A nitrogen blanketed glass reactor at atmospheric pressure, which was equipped with a temperature probe, an agitator, a condenser and a nitrogen inlet, was charged with 45 gms of polysiloxane hydride of the formula equilibrate M^{H}D₁₀M^{H} containing 51.2 cc/g of active hydrogen, 53.8 gms of the allyl ether with an allyl content of 10.2 weight percent, and 98.8 gms of 2-propanol; then 230 microliters of dibutylethanolamine was added as a buffer. The reaction mixture (homogeneous) was heated to 73° C. and platinum catalyst was introduced as 98 microliters of a 3.3% solution of chloroplatinic acid in ethanol, corresponding to 10 ppm of platinum. The reaction was exothermic and the temperature rose until 83° C. after 11 minutes (total time). The reaction was complete (i.e., the equilibrate SiH was consumed) after 1 hour. The copolymer was allowed to cool in the reactor for 30 minutes and then removed. The solvent was stripped out under vacuum. The equilibrate M^{H}D₁₀M^{H} was obtained by adding 30.7 g of M^{H}M^{H}, 169.3 g of D₄ with 163 microliters of trimethylsilyl trifluoromethanesulfonate. The glass flask was put on a rolling shaker for 24 hours to equilibrate and the following day dibutylethanolamine (272 microliters) was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a folded filter paper.

Example 15 (RH II) is a laboratory prepared material obtained from the hydrosilylation reaction between the equilibrate M^{H}D₈M^{H} and a 30% molar excess of an allyl started polyether with the formula of CH₂═CH—CH₂—O—(CH₂CH₂O)_{7.5}—H. A nitrogen blanketed glass reactor at atmospheric pressure, which was equipped with a temperature probe, an agitator, a condenser and a nitrogen inlet, was charged with 48 gms of polysiloxane hydride of the formula equilibrate M^{H}D₈M^{H} containing 61.7 cc/g of active hydrogen, 69.1 g of polyether with an allyl content of 10.2 weight percent, and 136 microliters of dibutylethanolamine as a buffer. The reaction mixture (heterogeneous) was heated to 72° C. and platinum catalyst was introduced as 117 microliters of a 3.3% solution of chloroplatinic acid in ethanol, corresponding to 10 ppm of platinum. The reaction was exothermic and the reactor temperature rose to 101° C. within 14 minutes. The reaction was complete (i.e., the equilibrate SiH was consumed) after 1 hour. The copolymer was allowed to cool in the reactor for 30 minutes and then removed. The equilibrate M^{H}D₈M^{H} was obtained as quoted in example 01.

Example 16 (RH III) is a laboratory prepared material obtained from the hydrosilylation reaction between the equilibrate MD₆D₂^{H}M and a 30% molar excess of an allyl started polyether with the formula of CH₂═CH—CH₂—O—(CH₂—CH₂—O)_{3.5}—H. A nitrogen blanketed glass reactor at atmospheric pressure, which was equipped with a temperature probe, an agitator, a condenser and a nitrogen inlet, was charged with 38 gms of polysiloxane hydride of the formula equilibrate MD₆D₂^{H}M containing 59.5 cc/g of active hydrogen, 28.4 g of polyether with an allyl content of 19.0 weight percent, and 77 microliters of dibutylethanolamine as a buffer. The reaction mixture (heterogeneous) was heated to 72° C. and platinum catalyst was introduced as 66 microliters of a 3.3% solution of chloroplatinic acid in ethanol, corresponding to 10 ppm of platinum. The reaction was exothermic and the reactor temperature rose to 85° C. within 30 minutes. The reaction was complete (i.e., the equilibrate SiH was consumed) after 1 hour. The copolymer was allowed to cool in the reactor for 30 minutes and then removed. The equilibrate MD₆D₂^{H}M was obtained by adding 42.2 g of MM and 122.2 g of D₄ and 35.6 g of MD₅₀^{H}M (or L31) with 163 microliters of trimethylsilyl trifluoromethanesulfonate. The glass flask was put on a rolling shaker for 24 hours to equilibrate and the next day 272 microliters of dibutylethanolamine was added for neutralization. The mixture was shaken on the rollers of the rolling shaker for 1 hour. There were some droplets on the walls of the glass so 3 spatulas of NaHCO₃ were added to further neutralize the mixture and then the mixture was filtered on a paper filter.

Example 17 (RH V) is a laboratory prepared material obtained from the hydrosilylation reaction between the equilibrate M^{H}D₂M^{H} and a 30% molar excess of an allyl started polyether CH₂═CH—CH₂—O—(CH₂CH₂O)_{7.5}CH₃. A nitrogen blanketed glass reactor at atmospheric pressure, which was equipped with a temperature probe, an agitator, a condenser and a nitrogen inlet, was charged with 20 gms of polysiloxane hydride of the formula equilibrate M^{H}D₂M^{H} containing 158.8 cc/g of active hydrogen, 77.7 gms of the allyl ether with an allyl content of 9.2 weight percent; then 115 microliters of dibutylethanolamine was added as a buffer. The reaction mixture (heterogeneous) was heated to 73° C. and platinum catalyst was introduced as 99 microliters of a 3.3% solution of chloroplatinic acid in ethanol, corresponding to 10 ppm of platinum. After no increase of temperature, a second addition of catalyst (10 ppm) is done (after 15 min total time) and a third addition (10 ppm) was done after 36 min (total time) still at 74° C. and then the thermostated bath was put at 90° C. and the temperature rose up to 92° C. after 120 minutes (total time). The reaction was complete (i.e., the equilibrate SiH was consumed) after 3 hours. The copolymer was allowed to cool in the reactor for 30 minutes and then removed. The equilibrate M^{H}D₂M^{H} was obtained as quoted in example 05.

Example 18 (RH VI) is a laboratory prepared material obtained from the hydrosilylation reaction between the equilibrate M^{H}D₄M^{H} and a 30% molar excess of an allyl started polyether CH₂═CH—CH₂—O—(CH₂CH₂O)_{7.5}CH₃. A nitrogen blanketed glass reactor at atmospheric pressure, which was equipped with a temperature probe, an agitator, a condenser and a nitrogen inlet, was charged with 28 gms of polysiloxane hydride of the formula equilibrate M^{H}D₄M^{H} containing 104.1 cc/g of active hydrogen, 71.4 gms of the allyl ether with an allyl content of 9.7 weight percent; then we added 116 microliter of dibutylethanolamine as a buffer. The reaction mixture (heterogeneous) was heated to 85° C. and platinum catalyst was introduced as 99 microliter of a 3.3% solution of chloroplatinic acid in ethanol, corresponding to 10 ppm of platinum. As no increase of temperature was observed, a second addition of platinum was done after 10 minutes (total time) and the reactor temperature rose to 101° C. within 23 minutes (total time). The reaction was complete (i.e., the equilibrate SiH was consumed) after 1 hour. The copolymer was allowed to cool in the reactor for 30 minutes and then removed. The equilibrate M^{H}D₄M^{H} was obtained as quoted in example 04.

Example 19 (RH VII) is a laboratory prepared material obtained from the hydrosilylation reaction between the equilibrate M^{H}D₂M^{H} and a 30% molar excess of trimethylolpropane monoallyl ether which has the formula of CH₂═CH—CH₂—O—CH₂—C(CH₂OH)₂—C₂H₅. A nitrogen blanketed glass reactor at atmospheric pressure, which was equipped with a temperature probe, an agitator, a condenser and a nitrogen inlet, was charged with 24 gms of polysiloxane hydride of the formula equilibrate M^{H}D₂M^{H} containing 158.8 cc/g of active hydrogen, 38.9 gms of the allyl ether with an allyl content of 23.3 weight percent of allyl; then 73 microliters of dibutylethanolamine was added as a buffer. The reaction mixture (heterogeneous) was heated to 85° C. and platinum catalyst was introduced as 73 microliters of a 3.3% solution of chloroplatinic acid in ethanol, corresponding to 10 ppm of platinum. The reaction was complete (i.e., the equilibrate SiH was consumed) after 2 hours. The copolymer was allowed to cool in the reactor for 30 minutes and then removed. The equilibrate M^{H}D₂M^{H} was obtained as quoted in example 01.

Example 20 (RH VIII) a laboratory prepared material obtained from the hydrosilylation reaction between the equilibrate M^{H}D₂M^{H} and a 30% molar excess of the 2-allyloxyethanol which has the formula CH₂═CH—CH₂—O—CH₂—CH₂OH. A nitrogen blanketed glass reactor at atmospheric pressure, which was equipped with a temperature probe, an agitator, a condenser and a nitrogen inlet, was charged with 24 gms of polysiloxane hydride of the formula equilibrate M^{H}D₂M^{H} containing 158.8 cc/g of active hydrogen, 22.7 gms of the allyl ether with an allyl content of 40 weight percent; then 54 microliters of dibutylethanolamine was added as a buffer. The reaction mixture (heterogeneous) was heated to 73° C. and platinum catalyst was introduced as 47 microliters of a 3.3% solution of chloroplatinic acid in ethanol, corresponding to 10 ppm of platinum. The reaction was exothermic and the reactor temperature rose to 154° C. after 1.5 min but after 30 min total time the reaction was not complete and an addition of 2g of 2-allyloxyethanol was done at 68° C. to complete the hydrosilation reaction. It will be understood herein that the terms hydrosilation and hydrosilylation are interchangeable. The reaction was complete (i.e., the equilibrate SiH was consumed) after 3 hours. The copolymer was allowed to cool in the reactor for 30 minutes and then removed. The equilibrate M^{H}D₂M^{H} was obtained as quoted in example 05.

Example 21 (RH IX) is a laboratory prepared material obtained from the hydrosilylation reaction between the equilibrate M^{H}D₂M^{H} and a 30% molar excess of the 2-Allyloxy1,2-propanediol (or Glycerin-1-allylether) which has the formula of CH₂═CH—CH₂—OCH₂—CH(OH)—CH₂OH. A nitrogen blanketed glass reactor at atmospheric pressure, which was equipped with a temperature probe, an agitator, a condenser and a nitrogen inlet, was charged with 24 gms of polysiloxane hydride of the formula equilibrate M^{H}D₂M^{H} containing 158.8 cc/g of active hydrogen, 29.3 gms of the allyl ether with an allyl content of 31 weight percent; then 62 microliters of dibutylethanolamine as a buffer was added. The reaction mixture (heterogeneous) was heated to 72° C. and platinum catalyst was introduced as 53 microliters of a 3.3% solution of chloroplatinic acid in ethanol, corresponding to 10 ppm of platinum. The reaction was exothermic and the reactor temperature rose to 147° C. after 1.5 min but another addition of 10 ppm platinum was done after 150 minutes (total time) at 71° C. (a five degrees increase followed this addition). The reaction was complete (i.e., the equilibrate SiH was consumed almost totally with less than 0.05 cc H₂/g of SiH remaining) after 3 hours. The copolymer was allowed to cool in the reactor for 30 minutes and then removed. The equilibrate M^{H}D₂M^{H} was obtained as quoted in example 05.

Example 22 (RH X) is a laboratory prepared material obtained from the hydrosilylation reaction between the equilibrate M^{H}D₂M^{H} and a 30% molar excess of the 2-allyl alcohol which has the formula of CH₂═CH—CH₂—OH. A nitrogen blanketed glass reactor at atmospheric pressure, which was equipped with a temperature probe, an agitator, a condenser and a nitrogen inlet, was charged with 20 gms of polysiloxane hydride of the formula equilibrate M^{H}D₂M^{H} containing 158.8 cc/g of active hydrogen, 10.8 gms of the allyl alcohol with an allyl content of 70 weight percent then 56 microliters of dibutylethanolamine was added as a buffer. The reaction mixture (heterogeneous) was heated to 61° C. and platinum catalyst was introduced as 48 microliters of a 3.3% solution of chloroplatinic acid in ethanol, corresponding to 10 ppm of platinum. The reaction was exothermic and the reactor temperature rose to 81° C. after 4 min but as the reaction was still not complete an addition of 10 ppm platinum catalyst was done after 25 min (total time) and at 62° C. and another addition of 10 ppm platinum catalyst plus 2 grams allyl alcohol after 150 minutes (total time) at 62° C. allowed the reaction to be completed. The reaction was finally complete (i.e., the equilibrate SiH was consumed) after 4 hours. The copolymer was allowed to cool in the reactor for 30 minutes and then removed. The excess of allyl alcohol was allowed to evaporate. The equilibrate M^{H}D₂M^{H} was obtained as quoted in example 05.

Example 23 (RH XI) is a laboratory prepared material obtained from the hydrosilylation reaction between the equilibrate M^{H}D₄M^{H} and a 30% molar excess of the trimethylolpropane monoallyl ether which has the formula of CH₂═CH—CH₂—O—CH₂—C(CH₂OH)₂—C₂H₅. A nitrogen blanketed glass reactor at atmospheric pressure, which was equipped with a temperature probe, an agitator, a condenser and a nitrogen inlet, was charged with 23.2 gms of polysiloxane hydride of the formula equilibrate M^{H}D₄ M^{H} containing 104.1 cc/g of active hydrogen, 24.8 gms of the allyl ether with an allyl content of 23.3 weight percent, then 56 microliters of dibutylethanolamine was added as a buffer. The reaction mixture (heterogeneous) was heated to 68° C. and platinum catalyst was introduced as 48 microliters of a 3.3% solution of chloroplatinic acid in ethanol, corresponding to 10 ppm of platinum. The reaction was exothermic and the reactor temperature rose to 126° C. after 2.5 min (total time). The reaction was complete (i.e., the equilibrate SiH was consumed) after 2 hours (total time). The copolymer was allowed to cool in the reactor for 30 minutes and then removed. The excess of allyl alcohol was allowed to evaporate. The equilibrate M^{H}D₄M^{H} was obtained as quoted in example 04.

Example 24 (RH XII) is a laboratory prepared material obtained from the hydrosilylation reaction between heptamethyltrisiloxane MD^{H}M, purified by distillation, and a 30% molar excess of the allyl started allylglycidylether with the formula of CH₂═CH—CH₂—OCH₂CHOCH₂ A nitrogen blanketed glass reactor at atmospheric pressure, which was equipped with a temperature probe, an agitator, a condenser and a nitrogen inlet, was charged with 55 gms of polysiloxane hydride of the general formula MD^{H}M containing 97.3 cc/g of active hydrogen, 35.5 gms of the allyl ether with an allyl content of 35.9 weight percent; then 105 microliters of dibutylethanolamine was added as a buffer. The reaction mixture (heterogeneous) was heated to 61° C. and platinum catalyst was introduced as 90 microliters of a 3.3% solution of chloroplatinic acid in ethanol, corresponding to 10 ppm of platinum. As no increase of temperature occurred, a second platinum addition (10 ppm) was done after 12 min (total time). The reaction was then exothermic and the reactor temperature rose up to 146° C. after 27.5 min (total time). After 2 hours (total time) we added 2g of the allyl ether and 10 ppm platinum at 61° C. The reaction was complete (i.e., the equilibrate SiH was consumed) after 4 hours. The copolymer was allowed to cool in the reactor for 30 minutes and then removed. MD^{H}M is 1,1,1,2,3,3,3 heptamethyltrisiloxane wherever it appears in the disclosure and MD^{H}M is distilled to a purity of 99 weight percent (wt %) wherever it appears in the disclosure.

Example 25 (RH XIII) is a laboratory prepared material obtained from the hydrosilylation reaction between heptamethyltrisiloxane MD^{H}M purified by distillation, and a 30% molar excess of trimethylolpropane monoallyl ether which has the formula of CH₂═CH—CH₂—O—CH₂—C(CH₂OH)₂—C₂H₅. A nitrogen blanketed glass reactor at atmospheric pressure, which was equipped with a temperature probe, an agitator, a condenser and a nitrogen inlet, was charged with 47.7 gins of polysiloxane hydride of the general formula MD^{H}M containing 97.3 cc/g of active hydrogen, 47.4 gms of the allyl ether with an allyl content of 23.3 weight percent; then we added 111 microliter of dibutylethanolamine as a buffer. The reaction mixture (heterogeneous) was heated to 76° C. and platinum catalyst was introduced as 95 microliters of a 3.3% solution of chloroplatinic acid in ethanol, corresponding to 10 ppm of platinum. The reaction was then exothermic and the reactor temperature rose to 135° C. after 2.5 min (total time). A second platinum addition (10 ppm) plus 2 grams of the allyl ether was done after 60 min at 77° C. The reaction was complete (i.e., the equilibrate SiH was consumed) after 2 hours. The copolymer was allowed to cool in the reactor for 30 minutes and then removed. MD^{H}M was obtained as quoted in example 24.

Example 26 (RH XIV) is a laboratory prepared material obtained from the hydrosilylation reaction between heptamethyltrisiloxane MD^{H}M, purified by distillation, and a 30% molar excess of an allyl started polyether CH₂═CH—CH₂—O—(CH₂—CH₂O)_{3.5}—H. A nitrogen blanketed glass reactor at atmospheric pressure, which was equipped with a temperature probe, an agitator, a condenser and a nitrogen inlet, was charged with 45 gms of polysiloxane hydride of the general formula MD^{H}M containing 97.3 cc/g of active hydrogen, 55 gms of the allyl ether with an allyl content of 19.0 weight percent; then 116 microliters of dibutylethanolamine was added as a buffer. The reaction mixture (heterogeneous) was heated to 73° C. and platinum catalyst was introduced as 100 microliters of a 3.3% solution of chloroplatinic acid in ethanol, corresponding to 10 ppm of platinum. The reaction was then a bit exothermic and the reactor temperature rose to 79° C. after 5 min (total time). A second platinum addition (10 ppm) was needed and was done after 60 min (total time). The reaction was complete (i.e., the equilibrate SiH was consumed) after 2 hours. The copolymer was allowed to cool in the reactor for 30 minutes and then removed. MD^{H}M was obtained as quoted in example 24.

Example 27 (RH XV) is a laboratory prepared material obtained from the hydrosilylation reaction between heptamethyltrisiloxane MD^{H}M, purified by distillation, and a 30% molar excess of an allyl started polyether CH₂═CH—CH₂—O—(CH₂—CH₂O)₁₂—H. A nitrogen blanketed glass reactor at atmospheric pressure, which was equipped with a temperature probe, an agitator, a condenser and a nitrogen inlet, was charged with 30 gms of polysiloxane hydride of the general formula MD^{H}M containing 97.3 cc/g of active hydrogen, 95.3 grams of the allyl ether with an allyl content of 7.3 weight percent; then 146 microliters of dibutylethanolamine was added as a buffer. The reaction mixture (heterogeneous) was heated to 73° C. and platinum catalyst was introduced as 125 microliters of a 3.3% solution of chloroplatinic acid in ethanol, corresponding to 10 ppm of platinum. The reaction was then exothermic and the reactor temperature rose to 103° C. after 23 min (total time). A second platinum addition (10 ppm) was needed and done after 60 min at 73° C. The reaction was complete (i.e., the equilibrate SiH was consumed) after 2 hours. The copolymer was allowed to cool in the reactor for 30 minutes and then removed. MD^{H}M was obtained as quoted in example 24.

Example 28 is a commercial product Silwet L77 available from GE Silicones.

Example 29 (RH XVII) is a laboratory prepared material obtained from the hydrosilylation reaction between heptamethyltrisiloxane MD^{H}M and a 30% molar excess of 2-allyloxyethanol which has the formula of CH₂═CH—CH₂—O—CH₂—CH₂OH. A nitrogen blanketed glass reactor at atmospheric pressure, which was equipped with a temperature probe, an agitator, a condenser and a nitrogen inlet, was charged with 50 gms of polysiloxane hydride of the general formula MD^{H}M containing 97.3 cc/g of active hydrogen, and 29 gms of the allyl ether with an allyl content of 40 weight percent; then 92 microliters of dibutylethanolamine was added as a buffer. The reaction mixture (heterogeneous) was heated to 74° C. and platinum catalyst was introduced as 79 microliters of a 3.3% solution of chloroplatinic acid in ethanol, corresponding to 10 ppm of platinum. The reaction was then exothermic and the reactor temperature rose to 147° C. after 8 min (total time). A second platinum addition was needed and done after 90 min (total time) at 71° C. The reaction was complete (i.e., the equilibrate SiH was consumed) after 2 hours (total time). The copolymer was allowed to cool in the reactor for 30 minutes and then removed. MD^{H}M was obtained as quoted in example 24.

Example 30 (RH XVIII) is a laboratory prepared material obtained from the hydrosilylation reaction between heptamethyltrisiloxane MD^{H}M and a 30% molar excess of 2-Allyloxy1,2-propanediol (Glycerin-1-allylether) which has the formula of CH₂═CH—CH₂—OCH₂—CH(OH)—CH₂OH. A nitrogen blanketed glass reactor at atmospheric pressure, which was equipped with a temperature probe, an agitator, a condenser and a nitrogen inlet, was charged with 40 gms of polysiloxane hydride of the general formula MD^{H}M containing 97.3 cc/g of active hydrogen, and 29.9 gms of the allyl ether with an allyl content of 31 weight percent; then 81 microliters of dibutylethanolamine was added as a buffer. The reaction mixture (heterogeneous) was heated to 72° C. and platinum catalyst was introduced as 70 microliters of a 3.3% solution of chloroplatinic acid in ethanol, corresponding to 10 ppm of platinum. The reaction was then exothermic and the reactor temperature rose to 129° C. after 4 min (total time). A second platinum addition (10 ppm) plus 2 grams of 2-Allyloxy1,2-propanediol was needed and was done after 90 min (total time) at 71° C. To complete the reaction a final 10 ppm platinum addition plus 1 gram of 2-Allyloxy1,2-propanediol was performed after 120 min (total time). The reaction was complete (i.e., the equilibrate SiH was consumed) after 4 hours (total time). The copolymer was allowed to cool in the reactor for 30 minutes and then removed. MD^{H}M was obtained as quoted in example 24.

Example 31 (RH XIX) is a laboratory prepared material obtained from the hydrosilylation reaction between heptamethyltrisiloxane MD^{H}M and a 30% molar excess of allyl alcohol which has the formula of CH₂═CH—CH₂—OH. A nitrogen blanketed glass reactor at atmospheric pressure, which was equipped with a temperature probe, an agitator, a condenser and a nitrogen inlet, was charged with 40 gms of polysiloxane hydride of the general formula MD^{H}M containing 97.3 cc/g of active hydrogen, 13.2 gms of the allyl alcohol with an allyl content of 70 weight percent; then 62 microliters of dibutylethanolamine was added as a buffer. The reaction mixture (heterogeneous) was heated up to 61° C. and platinum catalyst was introduced as 53 microliters of a 3.3% solution of chloroplatinic acid in ethanol, corresponding to 10 ppm of platinum. The reaction was then a bit exothermic with no completion of the reaction. A second platinum addition was needed (10 ppm) plus 1 gram of allyl alcohol and was done after 60 min (total time) at 62° C. The reaction was complete (i.e., the equilibrate SiH was consumed) after 2 hours (total time). The copolymer was allowed to cool in the reactor for 30 minutes and then removed. MD^{H}M was obtained as quoted in example 24.

Example 32 (RH XX) a laboratory prepared material obtained from the hydrosilylation reaction between the equilibrate M^{H}D₂M^{H} and a 30% molar excess of allylglycidylether with the formula CH₂═CH—CH₂—OCH₂CHOCH₂. A nitrogen blanketed glass reactor at atmospheric pressure, which was equipped with a temperature probe, an agitator, a condenser and a nitrogen inlet, was charged with 40 gms of polysiloxane hydride of the formula equilibrate M^{H}D₂M^{H} containing 158.8 cc/g of active hydrogen, and 42.1 gms of the allyl ether with an allyl content of 35.9 weight percent; then 95 microliters of dibutylethanolamine was added as a buffer. The reaction mixture (heterogeneous) was heated up to 70° C. and platinum catalyst was introduced as 82 microliters of a 3.3% solution of chloroplatinic acid in ethanol, corresponding to 10 ppm of platinum. The reaction was exothermic and the reactor temperature rose to 183° C. after 3 min (total time). A second addition of platinum (10 ppm) was needed and was done after 60 minutes at 72° C. The reaction was complete (i.e., the equilibrate SiH was consumed) after 3 hours. The copolymer was allowed to cool in the reactor for 30 minutes and then removed. The equilibrate M^{H}D₂M^{H} is obtained as quoted in Example 05.

Example 33 (RH XXI) is a laboratory prepared material obtained from the hydrosilylation reaction between the equilibrate M^{H}D₄M^{H} and a 30% molar excess of allylglycidylether with the formula CH₂═CH—CH₂—OCH₂CHOCH₂. A nitrogen blanketed glass reactor at atmospheric pressure, which was equipped with a temperature probe, an agitator, a condenser and a nitrogen inlet, was charged with 40 gms of polysiloxane hydride of the formula equilibrate M^{H}D₄M^{H} containing 104.1 cc/g of active hydrogen, 27.6 gms of the allyl ether with an allyl content of 35.9 weight percent; then 79 microliters of dibutylethanolamine was added as a buffer. The reaction mixture (heterogeneous) was heated up to 71° C. and platinum catalyst was introduced as 68 microliters of a 3.3% solution of chloroplatinic acid in ethanol, corresponding to 10 ppm of platinum. The reaction was exothermic and the reactor temperature rose to 180° C. within 1 minute. A second 10 ppm platinum addition in addition to 1 g of the allyl ether(it will be understood herein that the reference to the phrases “the allyl ether”, “the allyl alcohol”, “allyl ether”, or “allyl alcohol” or “allyl started polyether” refers to the specific allyl ether or allyl alcohol or “allyl started polyether” described in the example in which the phrase appears unless stated otherwise) was needed and done after 2 hours (total time) at 71° C. The reaction was complete (i.e., the equilibrate SiH was consumed) after 3 hours (total time). The copolymer was allowed to cool in the reactor for 30 minutes and then removed. The equilibrate M^{H}D₄M^{H} is obtained as quoted in example 04.

Example 34 (RH XXII) is a laboratory prepared material obtained from the hydrosilylation reaction between the equilibrate MDD^{H}M and a 30% molar of 2-allyloxyethanol with the formula CH₂═CH—CH₂—O—CH₂—CH₂OH. A nitrogen blanketed glass reactor at atmospheric pressure, which was equipped with a temperature probe, an agitator, a condenser and a nitrogen inlet, was charged with 40 gms of polysiloxane hydride of the formula equilibrate MD D^{H}M containing 72.9 cc/g of active hydrogen, 17.3 g of allyl started polyether with an allyl content of 40.0 weight percent, and 67 microliters of dibutylethanolamine as a buffer. The reaction mixture (heterogeneous) was heated up to 72° C. and platinum catalyst was introduced as 57 microliters of a 3.3% solution of chloroplatinic acid in ethanol, corresponding to 10 ppm of platinum. The reaction was complete (i.e., the equilibrate SiH was consumed) after 2 hours. The copolymer was allowed to cool in the reactor for 30 minutes and then removed. The equilibrate MDD^{H} M was obtained as quoted in Example 12.

Example 35 (RH XXIII) is a laboratory prepared material obtained from the hydrosilylation reaction between the equilibrate MDD^{H}M and a 30% molar excess of allyl started polyether CH₂═CH—CH₂—O—(CH₂—CH₂O)_{7.5}—H. A nitrogen blanketed glass reactor at atmospheric pressure, which was equipped with a temperature probe, an agitator, a condenser and a nitrogen inlet, was charged with 31 gms of polysiloxane hydride with the formula MDD^{H}M containing 72.9 cc/g of active hydrogen, 52.7 g of the above allyl started polyether with an allyl content of 10.2 weight percent, and 97 microliters of dibutylethanolamine as a buffer. The reaction mixture (heterogeneous) was heated up to 72° C. and platinum catalyst was introduced as 84 microliters of a 3.3% solution of chloroplatinic acid in ethanol, corresponding to 10 ppm of platinum. The reaction was complete (i.e., the equilibrate SiH was consumed) after 2 hours. The copolymer was allowed to cool in the reactor for 30 minutes and then removed. The equilibrate MDD^{H} M was obtained as quoted in Example 12.

Example 36 (RH XXIV) is a laboratory prepared material obtained from the hydrosilylation reaction between the equilibrate MDD^{H}M and a 30% molar excess of allyl started polyether CH₂═CH—CH₂—O—(CH₂—CH₂O)_{7.5}—CH₃. A nitrogen blanketed glass reactor at atmospheric pressure, which was equipped with a temperature probe, an agitator, a condenser and a nitrogen inlet, was charged with 35 gms of polysiloxane hydride of the formula equilibrate MDD^{H}M containing 72.9 cc/g of active hydrogen, 62.4 g of the allyl started polyether with an allyl content of 9.7 weight percent, and 113 microliters of dibutylethanolamine as a buffer. The reaction mixture (heterogeneous) was heated to 72° C. and platinum catalyst was introduced as 97 microliters of a 3.3% solution of chloroplatinic acid in ethanol, corresponding to 10 ppm of platinum. As no temperature increase occurred after 10 min (total time) 10 ppm platinum was added and the temperature of the thermostated bath was increased to 90° C. The temperature in the reactor rose to 110° C. after 20 min (total time). The reaction was complete (i.e., the equilibrate SiH was consumed) after 1 hour. The copolymer was allowed to cool in the reactor for 30 minutes and then removed. The equilibrate MDD^{H}M was obtained as quoted in Example 12.

Example 37 (RH XXV) is a laboratory prepared material obtained from the hydrosilylation reaction between the equilibrate MDD^{H}M and a 30% molar excess of Allylglycidylether with the formula of CH₂═CH—CH₂—OCH₂CHOCH₂. A nitrogen blanketed glass reactor at atmospheric pressure, which was equipped with a temperature probe, an agitator, a condenser and a nitrogen inlet, was charged with 35 gms of polysiloxane hydride of the formula equilibrate MDD^{H}M containing 72.9 cc/g of active hydrogen, 16.9 g of the allyl ether with an allyl content of 35.9 weight percent, and 60 microliters of dibutylethanolamine as a buffer. The reaction mixture (heterogeneous) was heated to 85° C. and platinum catalyst was introduced as 52 microliters of a 3.3% solution of chloroplatinic acid in ethanol, corresponding to 10 ppm of platinum. As no temperature increase occurred after 10 min (total time) we added 10 ppm platinum. The temperature in the reactor rose to 92° C. after 20 min (total time). The reaction was complete (i.e., the equilibrate SiH was consumed) after 3 hours. The copolymer was allowed to cool in the reactor for 30 minutes and then removed. The equilibrate MDD^{H} M is obtained as quoted in Example 12.

Example 38 (RH XXVI) is a laboratory prepared material obtained from the hydrosilylation reaction between the equilibrate MDD^{H}M and a 30% molar excess of trimethylolpropane monoallyl ether (TMPMAE) which has the formula of CH₂═CH—CH₂—O—CH₂—C(CH₂OH)₂—C₂H₅. A nitrogen blanketed glass reactor at atmospheric pressure, which was equipped with a temperature probe, an agitator, a condenser and a nitrogen inlet, was charged with 35 gms of polysiloxane hydride of the formula equilibrate MDD^{H}M containing 72.9 cc/g of active hydrogen, 26g of the trimethylolpropane monoallyl ether with an allyl content of 23.3 weight percent, and 71 microliters of dibutylethanolamine as a buffer. The reaction mixture (heterogeneous) was heated to 74° C. and platinum catalyst was introduced as 61 microliters of a 3.3% solution of chloroplatinic acid in ethanol, corresponding to 10 ppm of platinum. The temperature rose to 134° C. after 2 minutes (total time). As the reaction was still not complete after 3 hours (total time) 10 ppm platinum was added in addition to 1 gram trimethylolpropane monoallyl ether at 73° C. The reaction was complete (i.e., the equilibrate SiH was consumed) after 4 hours. The copolymer was allowed to cool in the reactor for 30 minutes and was then removed. The equilibrate MDD^{H}M was obtained as quoted in Example 12.

Example 39 (RH XXVII) is a laboratory prepared material obtained from the hydrosilylation reaction between the equilibrate MDD^{H}M and a 30% molar excess of 2-allyloxy1,2-propanediol (Glycerin-1-allylether) which has the formula of CH₂═CH—CH₂—OCH₂—CH(OH)—CH₂OH. A nitrogen blanketed glass reactor at atmospheric pressure, which was equipped with a temperature probe, an agitator, a condenser and a nitrogen inlet, was charged with 40 gms of polysiloxane hydride of the formula equilibrate MDD^{H}M containing 72.9 cc/g of active hydrogen, 22.4 g of the allyl ether with an allyl content of 31 weight percent, and 73 microliters of dibutylethanolamine as a buffer. The reaction mixture (heterogeneous) was heated to 73° C. and platinum catalyst was introduced as 62 microliters of a 3.3% solution of chloroplatinic acid in ethanol, corresponding to 10 ppm of platinum. The temperature rose to 124° C. after 5 minutes. As the reaction was not complete after 60 min (total time) 10 ppm platinum and 2 grams of the allyl ether were added. The reaction was complete (i.e., the equilibrate SiH was consumed) after 2 hours (total time). The copolymer was allowed to cool in the reactor for 30 minutes and then removed. The equilibrate MDD^{H}M was obtained as quoted in Example 34.

Example 40 (RH XXVIII) is a laboratory prepared material obtained from the hydrosilylation reaction between the equilibrate MDD^{H}M and a 30% molar excess of 2-allyl alcohol which has the formula of CH₂═CH—CH₂—OH. A nitrogen blanketed glass reactor at atmospheric pressure, which was equipped with a temperature probe, an agitator, a condenser and a nitrogen inlet, was charged with 40 gms of polysiloxane hydride of the formula equilibrate MDD^{H}M containing 72.9 cc/g of active hydrogen, 9.9 g of the allyl alcohol above with an allyl content of 70 weight percent of the allyl group, and 58 microliters of dibutylethanolamine as a buffer. The reaction mixture (heterogeneous) was heated up to 61° C. and platinum catalyst was introduced as 50 microliters of a 3.3% solution of chloroplatinic acid in ethanol, corresponding to 10 ppm of platinum. The temperature in the reactor did not rise. After 15 minutes (total time), the temperature of the thermostated bath was increased to 80° C. After 60 min (total time), 10 ppm platinum were added at 74° C. After 2 hours (total time), the temperature of the thermostated bath was increased to 90° C. Another addition of 10 ppm platinum was performed at 74° C. after 200 min (total time). The temperature rose at 86° C. and to complete the reaction 2 grams of the allyl ether were added at 74° C. after 300 min (total time). The reaction was finally complete (i.e., the equilibrate SiH was consumed) after 6 hours. The copolymer was allowed to cool in the reactor for 30 minutes and then removed. The equilibrate MDD^{H} M was obtained as quoted in Example 12.

Example 41 (Y-17015) is a commercial product from GE.

Example 42 (WARO 2590) is a laboratory prepared material obtained from the hydrosilylation reaction between M^{H}M^{H} and an allyloxyethanol which has the formula of CH₂═CH—CH₂—O—C₂H₄OH, with the allyloxyethanol added in molar excess (30%) in the presence of the Karstedt PTS type (“platinum tetravinyl siloxane”) catalyst (1% platinum in toluene). In a bottle with a magnetic stirrer, a dropping funnel and a refluxing condenser, flushed with nitrogen, 26.26 grams of the allyl ether allyloxyethanol, was mixed with 0.1 gram PTS (containing 1% platinum metal) and the mixture is heated to 70° C. Then 13.4 g of M^{H}M^{H}, is added dropwise during 10 minutes to complete the reaction. The system heated up by itself up to 140° C. during the hydrosilylation. The mixture was further stirred for 60 min at 130° C. and left for cooling down. The reaction product is predominantly Si—C linked as seen by NMR. The weight of the product obtained was 37.4 g. M^{H}M^{H} is commercially available from Fluka as indicated above.

Example 43 (WARO 2591) is a laboratory prepared material obtained from the reaction product of the hydrosilylation of the equilibrate M^{H}M^{H} with 30% molar excess of an allyl started polyether with the formula CH₂═CH—CH₂—O—(CH₂CH₂O)_{4.1}—H in the presence of the Karstedt PTS type catalyst (1% platinum in toluene). In a bottle with a magnetic stirrer, a dropping funnel and a refluxing condenser, flushed with nitrogen, 33.93 g of the allyl started polyether was mixed with 0.1 gram PTS (containing 1% Platinum metal) and the mixture was heated to 70° C. Then 6.7 grams of M^{H}M^{H} is added dropwise during 20 minutes to complete the reaction. The system heated up by itself up to 120° C. during the hydrosilylation. The mixture was further stirred for 60 min at 130° C. and left for cooling down. The reaction product is predominantly Si—O—C linked as seen by NMR. The weight of the product obtained was 38.4 g. M^{H}M^{H} is commercially available from Fluka as indicated above.

Example 44 (WARO 2592) is a laboratory prepared material obtained from the hydrosilylation reaction between M^{H}M^{H}, and an allyl started polyether with the formula of CH₂═CHCH₂—O—(CH₂CH₂O)_{5.7}H added in molar excess (30%) and in the presence of the Karstedt PTS type catalyst. In a bottle with a magnetic stirrer, a dropping funnel and a refluxing condenser, flushed with nitrogen, 47.5 g of the allyl started polyether was mixed with 0.1 gram PTS (containing 1% Platinum) and the mixture was heated to 70° C. Then 6.7 g of M^{H}M^{H} is added dropwise during 20 minutes to complete the reaction. The system heated up by itself up to 120° C. during the hydrosilylation. The mixture was further stirred for 60 min at 130° C. and left for cooling down. The reaction product is predominantly Si—O—C linked as seen by NMR. The weight of the product obtained was 52.7 g. M^{H}M^{H} is commercially available from Fluka as indicated above.

Example 45 (WARO 2593) is a laboratory prepared material obtained from the hydrosilylation reaction between M^{H}M^{H}, and an allyl started polyether with the formula of CH₂═CHCH₂—O—(CH₂CH₂O)_{6.5}H added in molar excess (30%) in the presence of Karstedt PTS type catalyst. In a bottle with a magnetic stirrer, a dropping funnel and a refluxing condenser, flushed with nitrogen, 49.53 grams of the allyl started polyether, was mixed with 0.1 gram PTS (containing 1% Platinum metal) and the mixture was heated to 70° C. Then 6.7 grams of M^{H}M^{H}, was added dropwise during 20 minutes to complete the reaction. The system heated up by itself up to 130° C. during the hydrosilylation. The mixture was further stirred for 60 min at 130° C. and left for cooling down. The reaction product is predominantly Si—C linked as seen by NMR. The weight of the product obtained was 40.6 g. M^{H}M^{H} is commercially available from Fluka as indicated above.

Example 46 (WARO 2594) is a laboratory prepared material obtained from the hydrosilylation reaction between M^{H}M^{H}, and an allyl started polyether with the formula of CH₂═CH—CH₂—O—(C(H)(CH₃)—CH₂O)_{1.6}H added in molar excess (30%) in the presence of the Karstedt PTS type catalyst. In a bottle with a magnetic stirrer, a dropping funnel and a refluxing condenser, flushed with nitrogen, 39.0 grams of the allyl started polyether, was mixed with 0.1 gram PTS (containing 1% Platinum) and the mixture was heated to 70° C. Then 13.4 grams of M^{H}M^{H}, was added dropwise during 10 minutes. The system heated up by itself up to 140° C. during the hydrosilylation. The mixture was further stirred for 60 min at 130° C. and let for cooling down. The reaction product is predominantly Si—C linked as seen by NMR. The weight of the product obtained was 52 g. M^{H}M^{H} is commercially available from Fluka as indicated above.

Example 47 (WARO 2595) is a laboratory prepared material obtained from the hydrosilylation reaction between M^{H}M^{H}, and a vinyl started polyether with the formula of CH₂═CH—O—(CH₂—CH₂O)₂H with the vinyl started polyether added in molar excess (30%) in the presence of the Karstedt PTS type catalyst. In a bottle with a magnetic stirrer, a dropping funnel and a refluxing condenser, flushed with nitrogen, 34.06 grams of the vinyl started polyether, was mixed with 0.1 gram PTS (containing 1% Platinum) and the mixture was heated to 70° C. Then 13.4 grams of M^{H}M^{H}, was added dropwise during 15 minutes. The system heated up by itself up to 120° C. during the hydrosilylation. The mixture was further stirred for 60 min at 130° C. and let for cooling down. The reaction product is predominantly Si—O—C linked as seen by NMR. The weight of the product obtained was 44.6 g. M^{H}M^{H} is commercially available from Fluka as indicated above.

Example 48 (WARO 2596) is a laboratory prepared material obtained from the hydrosilylation reaction between M^{H}M^{H}, and a vinyl started polyether with the formula of CH₂═CH—O—(CH₂—CH₂O)₂—CH₃ with the vinyl started polyether added in molar excess (30 in the presence of the Karstedt PTS type catalyst. In a bottle with a magnetic stirrer, a dropping funnel and a refluxing condenser, flushed with nitrogen, 49.14 grams of the vinyl started polyether, was mixed with 0.1 gram PTS (containing 1% Platinum) and the mixture was heated to 70° C. Then 13.4 grams of M^{H}M^{H}, was added dropwise during 15 minutes. The system heated up by itself up to 120° C. during the hydrosilylation. The mixture was further stirred for 60 min at 130° C. and left for cooling down. The reaction product was predominantly Si—O—C linked as seen by NMR. The weight of the product obtained was 57.5 g. M^{H}M^{H} is commercially available from Fluka as indicated above.

Example 49 (WARO 2597) is a laboratory prepared material obtained from the hydrosilylation reaction between M^{H}M^{H}, and a vinyl started polyether with the formula of CH₂═CH—O—(CH₂—CH₂O)₄—CH═CH₂ with the vinyl started polyether added in molar excess (30%) in the presence of the Karstedt PTS type catalyst. In a bottle with a magnetic stirrer, a dropping funnel and a refluxing condenser, flushed with nitrogen, 31.85 grams of the vinyl started polyether, was mixed with 0.1 gram PTS (containing 1% Platinum) and the mixture was heated to 70° C. Then 6.7 grams of M^{H}M^{H}, were added dropwise during 20 minutes to complete the reaction. The mixture was further stirred for 60 min at 130° C. and left for cooling down. The reaction product was predominantly Si—C linked as seen by NMR. The weight of the product obtained was 35.1 g. M^{H}M^{H} is commercially available from Fluka as indicated above

Example 50 (WARO 3609) is a laboratory prepared material obtained from the hydrosilylation reaction between M^{H}M^{H} and the trimethylolpropane monoallyl ether with the allyl ether added in molar excess (30%) in the presence of the Karstedt PTS type catalyst. In a bottle with a magnetic stirrer, a dropping funnel and a refluxing condenser, flushed with nitrogen, 45.24 g of the allyl ether was mixed with 0.1 gram PTS (containing 1% Platinum) and the mixture was heated to 70° C. Then 13.4 g of M^{H}M^{H}, was added dropwise during 10 minutes The system heated up by itself up to 120° C. during the hydrosilylation. The mixture was further stirred for 60 min at 130° C. and left for cooling down. The reaction product is predominantly Si—C linked as seen by NMR. The weight of the product obtained was 57.1 g. M^{H}M^{H} is commercially available from Fluka as indicated above.

Example 51 (WARO 3743) is a laboratory prepared material obtained from the hydrosilylation reaction between M^{H}M^{H} and an allyl started polyether with the formula of CH₂═CH—CH₂—(CH₂—CH₂O)_{5.8}—CH₃ with the allyl started polyether added in molar excess (30%) in the presence of the catalyst H₂PtCl₆ (containing 1% Platinum). In a bottle with a magnetic stirrer, a dropping funnel and a refluxing condenser, flushed with nitrogen, 43.2 g of the allyl started polyether were mixed with 0.1 gram H₂PtCl₆ (containing 1% Platinum metal) and the mixture was heated to 75° C. Then 13.4 g of M^{H}M^{H} were added dropwise during 15 minutes. The system heated up by itself up to 90° C. during the hydrosilylation. The mixture was further stirred for 80 min at 130° C. and left for cooling down. The reaction product was predominantly Si—C linked as seen by NMR. The weight of the product obtained was 49.1 g. M^{H}M^{H} is commercially available from Fluka as indicated above.

Example 52 (WARO 3744) is a laboratory prepared material obtained from the hydrosilylation reaction between M^{H}M^{H} and an allyl started polyether with the formula of CH₂═CH—CH₂—O—(CH₂—CH₂O)_{6.8}—CH₃ with the allyl started polyether added in molar excess (30%) in the presence of the catalyst H₂PtCl₆ (containing 1% Platinum). In a bottle with a magnetic stirrer, a dropping funnel and a refluxing condenser, flushed with nitrogen, 4.0 g of the allyl started polyether were mixed with 0.56 g of M^{H}M^{H}. The mixture was heated up to 70° C. and the catalyst 0.02 gram H₂PtCl₆ (containing 1 percent platinum metal) was added. The system did not heat up by itself during the hydrosilylation. The mixture was further stirred for 60 min at 130° C. and let for cooling down. The reaction product was predominantly Si—C linked as seen by NMR. The weight of the product obtained was 4.5 g. M^{H}M^{H} is commercially available from Fluka as indicated above.

Example 53 (WARO 3745) is a laboratory prepared material obtained from the hydrosilylation reaction between M^{H}M^{H} and an allyl started polyether with the formula of CH₂═CH—CH₂—O—(CH₂—CH₂O)_{4.1}—CH₃ with the allyl started polyether added in molar excess (30%) in the presence of the catalyst H₂PtCl₆ (containing 1% Platinum). In a bottle with a magnetic stirrer, a dropping funnel and a refluxing condenser, flushed with nitrogen, 33.2 g of the allyl started polyether were mixed with 0.1 gram H₂PtCl₆ (containing 1% Platinum) and the mixture was heated to 72° C. Then 6.7 g of M^{H}M^{H} were added dropwise during 5 minutes The system heated up by itself up to 92° C. during the hydrosilylation. The mixture was further stirred for 70 min at 130° C. and left for cooling down. The reaction product was predominantly Si—C linked as seen by NMR. The weight of the product obtained was 4.5 g. M^{H}M^{H} is commercially available from Fluka as indicated above.

Example 54 (WARO 2598) is a laboratory prepared material obtained from the hydrosilylation reaction between M^{H}DM^{H} and an allyl started polyether with the formula of CH₂═CH—CH₂—O—(CH₂—CH₂O)H with the allyl started polyether added in molar excess (30%) in the presence of the Karstedt PTS type catalyst. In a bottle with a magnetic stirrer, a dropping funnel and a refluxing condenser, flushed with nitrogen, 26.26 g of the allyl ether were mixed with 0.1 gram PTS (containing 1% Platinum) and the mixture was heated to 70° C. Then 13.4 g of M^{H}DM^{H} was added dropwise during 20 minutes. The system heated up by itself up to 150° C. during the hydrosilylation. The mixture was further stirred for 60 min at 140° C. and left for cooling down. The reaction product was predominantly Si—C linked as seen by NMR. The weight of the product obtained was 45.5 g. The equilibrate M^{H}DM^{H} was obtained as follows: 600 g of M^{H}DM^{H} were obtained from the equilibration of 1025g M^{H}M^{H} and 3800g of M^{H}D₂M^{H} (see preparation in example 05) in the presence of 120 g Levatit K2641 (a sulphonic acid modified polystyrene ion exchanger available from Lanxess) under reflux for 3 hours (the temperature went up to 97° C.), and after cooling, the ion exchanger Levatit was filtrated through a folded paper filter with a pore size of 10 μm. The final product was distilled to get a product with 96% purity.

Example 55 (WARO 2599) is a laboratory prepared material obtained from the hydrosilylation reaction between the equilibrate M^{H}DM^{H} with 30% molar excess of the allyl started of formula CH₂═CH—CH₂—O—(CH₂CH₂O)_{4.1}—H in the presence of the Karstedt PTS type catalyst In a bottle with a magnetic stirrer, a dropping funnel and a refluxing condenser, flushed with nitrogen, 33.93 g of the allyl ether were mixed with 0.1 gram PTS (containing 1 percent platinum) and the mixture was heated to 70° C. Then 10.4 g of M^{H}DM^{H} were added dropwise during 10 minutes. The system heated up by itself up to 130° C. during the hydrosilylation. The mixture was further stirred for 60 min at 130° C. and left for cooling down. The reaction product was predominantly Si—C linked as seen by NMR. The weight of the product obtained was 42.8 g. The equilibrate M^{H}DM^{H} was obtained as quoted in example 54.

Example 56 (WARO 3601) is the reaction product of the hydrosilylation of the equilibrate M^{H}DM^{H} with 30% molar excess of the allyl started of formula CH₂═CHCH₂—O—(CH₂CH₂O)_{5.7}—H in the presence of the Karstedt PTS type catalyst. In a bottle with a magnetic stirrer, a dropping funnel and a refluxing condenser, flushed with nitrogen, 47.5 g of the allyl ether were mixed with 0.1 gram PTS (containing 1% Platinum) and the mixture was heated to 70° C. Then 10.4 g of M^{H}DM^{H} was added dropwise during 10 minutes. The system heated up by itself up to 120° C. during the hydrosilylation. The mixture was further stirred for 60 min at 150° C. and left for cooling down. The reaction product was predominantly Si—C linked as seen by NMR. The weight of the product obtained was 52.7 g. The equilibrate M^{H}DM^{H} was obtained as quoted in example 54.

Example 57 (WARO 3602) is a laboratory prepared material obtained from the hydrosilylation reaction between the equilibrate M^{H}DM^{H} with 30% molar excess of the allyl started polyether of formula CH₂═CHCH₂—O—(CH₂CH₂O)_{6.5}—H in the presence of the Karstedt PTS type catalyst In a bottle with a magnetic stirrer, a dropping funnel and a refluxing condenser, flushed with nitrogen, 49.53 g of the allyl ether were mixed with 0.1 gram PTS (containing 1 percent Platinum) and the mixture was heated to 70° C. Then 10.4 g of M^{H}DM^{H} were added dropwise during 10 minutes. The system heated up by itself up to 140° C. during the hydrosilylation. The mixture was further stirred for 60 min at 150° C. and left for cooling down. The reaction product was predominantly Si—C linked as seen by NMR. The weight of the product obtained was 58.7 g. The equilibrate M^{H}DM^{H} was obtained as quoted in example 54.

Example 58 (WARO 3603) is a laboratory prepared material obtained from the hydrosilylation reaction between the equilibrate M^{H}DM^{H} with 30% molar excess of the allyl started of formula CH₂═CHCH₂—O—(C(H)(CH₃)—CH₂O)_{1.6}—H in the presence of the Karstedt PTS type catalyst. In a bottle with a magnetic stirrer, a dropping funnel and a refluxing condenser, flushed with nitrogen, 39.0 g of the allyl ether were mixed with 0.1 gram PTS (containing 1 weight percent platinum metal) and the mixture was heated to 70° C. Then 20.8 g of M^{H}DM^{H}, were added dropwise during 10 minutes. The system heated up by itself up to 160° C. during the hydrosilylation. The mixture was further stirred for 60 min at 140° C. and left for cooling down. The reaction product was predominantly Si—C linked as seen by NMR. The weight of the product obtained was 58.2 g. The equilibrate M^{H}DM^{H} was obtained as quoted in example 54.

Example 59 (WARO 3604) is a laboratory prepared material obtained from the hydrosilylation reaction between the equilibrate M^{H}DM^{H} with 30% molar excess of the vinyl started polyether of formula CH₂═CH—O—(CH₂—CH₂O)₂—H in the presence of the Karstedt PTS type catalyst. In a bottle with a magnetic stirrer, a dropping funnel and a refluxing condenser, flushed with nitrogen, 34.06 g of the vinyl ether were mixed with 0.1 gram PTS (containing 1% Platinum) and the mixture was heated to 70° C. Then 20.8 g of M^{H}DM^{H} were added dropwise during 15 minutes. The system heated up by itself up to 150° C. during the hydrosilylation. The mixture was further stirred for 60 min at 140° C. and left for cooling down. The reaction product was predominantly Si—C linked as seen by NMR. The weight of the product obtained was 53.1 g. The equilibrate M^{H}DM^{H} was obtained as quoted in example 54.

Example 60 (WARO 3605) is a laboratory prepared material obtained from the hydrosilylation reaction between the equilibrate M^{H}DM^{H} with 30% molar excess of the vinyl started polyether of formula CH₂═CH—O—(CH₂—CH₂O)₃—CH₃ in the presence of the Karstedt PTS type catalyst. In a bottle with a magnetic stirrer, a dropping funnel and a refluxing condenser, flushed with nitrogen, 33.0 g of the vinyl ether were mixed with 0.1 gram PTS (containing 1% Platinum) and the mixture was heated to 70° C. Then 13.96 g of M^{H}DM^{H} were added dropwise during 10 minutes. The system heated up by itself up to 110° C. during the hydrosilylation. The mixture was further stirred for 60 min at 140° C. and left for cooling down. The reaction product was predominantly Si—C linked as seen by NMR. The weight of the product obtained was 43.9 g. The equilibrate M^{H}DM^{H} was obtained as quoted in example 54.

Example 61 (WARO 3606) is a laboratory prepared material obtained from the hydrosilylation reaction between the equilibrate M^{H}DM^{H} with 30% molar excess of the vinyl started polyether of formula CH₂═CH—O—(CH₂—CH₂O)₄—CH═CH₂ in the presence of the Karstedt PTS type catalyst. In a bottle with a magnetic stirrer, a dropping funnel and a refluxing condenser, flushed with nitrogen, 31.85 g of the vinyl ether were mixed with 0.1 gram PTS (containing 1 percent platinum metal) and the mixture was heated to 70° C. Then 10.4 g of M^{H}DM^{H} were added dropwise during 10 minutes. The system heated up by itself up to 100° C. during the hydrosilylation. The mixture was further stirred for 60 min at 150° C. and left for cooling down. The reaction product was predominantly Si—C linked as seen by NMR. The weight of the product obtained was 39.2 g. The equilibrate M^{H}DM^{H} was obtained as quoted in example 54.

Example 62 (WARO 3610) is a laboratory prepared material obtained from the hydrosilylation reaction between the equilibrate M^{H}DM^{H} with 30% molar excess of the allyl started trimethylolpropane monoallyl ether in the presence of the Karstedt PTS type catalyst. In a bottle with a magnetic stirrer, a dropping funnel and a refluxing condenser, flushed with nitrogen, 22.62 g of the allyl ether were mixed with 0.1 gram PTS (containing 1 percent Platinum) and the mixture is heated to 70° C. Then 10.4 g of M^{H}DM^{H} were added dropwise during 10 minutes. The system heated up by itself up to 150° C. during the hydrosilylation. The mixture was further stirred for 60 min at 150° C. and left for cooling down. The reaction product is predominantly Si—C linked as seen by NMR. The weight of the product obtained was 31.4 g. The equilibrate M^{H}DM^{H} was obtained as quoted in example 54.

Example 63 (WARO 3748) is a laboratory prepared material obtained from the hydrosilylation reaction between the equilibrate M^{H}DM^{H} with 30% molar excess of the allyl started polyether of formula CH₂═CH—CH₂—O—(CH₂—CH₂O)_{6.9}—CH₃ in the presence of the Karstedt PTS type catalyst. In a bottle with a magnetic stirrer, a dropping funnel and a refluxing condenser, flushed with nitrogen, 10.4 g of the allyl started polyether were mixed with 0.1 gram PTS (containing 1% Platinum) and the mixture was heated to 70° C. Then 10.4 g of M^{H}DM^{H} were added dropwise during 5 minutes. The system heated up by itself up to 148° C. during the hydrosilylation. The mixture was further stirred for 90 min at 130° C. and left for cooling down. The reaction product was predominantly Si—C linked as seen by NMR. The weight of the product obtained was 57g. The equilibrate M^{H}DM^{H} was obtained as quoted in example 54.

Example 64 (WARO 3749) is a laboratory prepared material obtained from the hydrosilylation reaction between the equilibrate M^{H}DM^{H} with 30% molar excess of the allyl started polyether of formula CH₂═CH—CH₂—O—(CH₂—CH₂O)_{5.8}—CH₃ in the presence of the Karstedt PTS type catalyst. In a bottle with a magnetic stirrer, a dropping funnel and a refluxing condenser, flushed with nitrogen, 43.2 g of the allyl polyether were mixed with 0.1 gram PTS (containing 1% Platinum metal) and the mixture was heated to 76° C. Then 10.4 g of M^{H}DM^{H} were added dropwise during 7 minutes. The system heated up by itself up to 150° C. during the hydrosilylation. The mixture was further stirred for 60 min at 130° C. and left for cooling down. The reaction product was predominantly Si—C linked as seen by NMR. The weight of the product obtained was 54.2 g. The equilibrate M^{H}DM^{H} was obtained as quoted in example 54.

Example 65 (WARO 3751) is a laboratory prepared material obtained from the hydrosilylation reaction between the equilibrate M^{H}DM^{H} with 30% molar excess of the allyl started polyether of formula CH₂═CH—CH₂—O—(CH₂—CH₂O)_{4.1}—CH₃ in the presence of the Karstedt PTS type catalyst. In a bottle with a magnetic stirrer, a dropping funnel and a refluxing condenser, flushed with nitrogen, 33.2 g of the allyl polyether were mixed with 0.1 gram PTS (containing 1% Platinum metal) and the mixture was heated to 82° C. Then 10.4 g of M^{H}DM^{H} were added dropwise during 7 minutes. The system heated up by itself up to 130° C. during the hydrosilylation. The mixture was further stirred for 60 min at 130° C. and left for cooling down. The reaction product was predominantly Si—C linked as seen by NMR. The weight of the product obtained was 43.6 g. The equilibrate M^{H}DM^{H} was obtained as quoted in example 54.

Example 66 (Silwet L-7280) is a commercial product from GE Silicones.

Example 67 (Silwet L-7607) is a commercial product from GE Silicones.

Example 68 (Y-14759) is a commercial product from GE Silicones

Example 69 (Y-17188) is an experimental product made by blending Y-17015 (40 wt %) and UCON 50H1500 (60 wt %). UCON 50H1500 is a commercial material available from Dow Chemicals.

Example 70 (Y-17189) is an experimental product made by blending Pluronic 17R2 (40 w-%), Rhodasurf DA-530 (30 wt %) and Y-17015 (30 wt %). Pluroninc 17R2 is available from BASF Chemicals and Rhodasurf DA-530 is available Rhodia Chemicals.

Example 71 (Y-17190) is an experimental product made by blending Genapol X50 (30 wt %); Pluronic L-62 (40 wt %) and Y-17015 (30 wt %). Genapol X50 is available from Clariant Chemicals and Pluroninc L-62 is available from BASF Chemicals.

Example A is an organic demulsifier provided by industry as Reference B which belongs to the family of ethoxylated alcohol. Example B is an organic demulsifier provided by industry as Reference C which belongs to the family of glycosides.

Example C is a trade secret as described above. No separation in Example C was observed at 2% 1% and 0.5% and thus is not included in Tables 2a, 2b and 2c.

TABLE 2a
Amount of aqueous phase (in volume % based on the whole volume of the initial mud sample) versus
time during the phase separation of 50 g mud samples treated by different demulsifiers at a treat
rate of 2% w/w (weight of demulsifier/weight of mud) from Turbiscan measurements at 29° C.
(2% w/w of demulsifier corresponds to 1 g of demulsifier in 50 g of mud). For examples 43, 55 and
56 smaller amounts of samples were available so we used 0.4 g in addition to 20 g mud.

| | concentration | | | | | | | | | |
|---|---|---|---|---|---|---|---|---|---|---|
| | weight percent | | | | | | | | | percent aqueous |
| | (weight of | | | | | | | | | phase + oil |
| | demulsifier/ | Volume % aqueous phase after | | | | | | | | phase after |
| | weight of mud) | 2 min | 5 min | 10 min | 60 min | 6 h | 8 h | 11 h | 15 h | 21 hours |
| Example A | 2% | 16 | 27.7 | 35.2 | 44.6 | 50.7 | 52.35 | 53.5 | 55.2 | 56.6 |
| Example 10B | 2% | 15.7 | 20.7 | 27 | 38.9 | 43.2 | 43.9 | 44.6 | 45.1 | 46.1 |
| Example 41 | 2% | 44.6 | 50.9 | 53.8 | 58.6 | 60.6 | 60.7 | 55.8 | 57.3 | 61.1 |
| Example B | 2% | 27.0 | 37.0 | 41.7 | 48.6 | 53.5 | 55.1 | 56.9 | 58.6 | 60.1 |
| Example 66 | 2% | 39.5 | 43.2 | 45.6 | 50.1 | 54.7 | 56.1 | 57.6 | 59.1 | 60.5 |
| Example 28 | 2% | 39.6 | 44.3 | 46.6 | 50.4 | 53.1 | 53.6 | 55.4 | 57.38 | 59.9 |
| Example 12 | 2% | 41.6 | 43.2 | 45.6 | 50.1 | 54.7 | 56.1 | 57.6 | 59.1 | 60.5 |
| Example 13 | 2% | 16.8 | 26.8 | 35.2 | 48.4 | 53.2 | 54.3 | 55.8 | 57.8 | 59.7 |
| Example 43 | 2% | 23.9 | 34.7 | 41 | 49.8 | 53.5 | 54.3 | 55.1 | 56.1 | 56.7 |
| Example 55 | 2% | 21.7 | 32 | 38.8 | 49.1 | 53.5 | 54.6 | 55.6 | 55.9 | 56.5 |
| Example 56 | 2% | 21 | 30.8 | 38.1 | 47.9 | 51.6 | 52.2 | 53.1 | 534 | 54.0 |

TABLE 2b
Amount of aqueous phase (in volume % based on the whole volume of the initial sample) versus time during the phase separation
of 50 g mud samples treated by different demulsifiers at a treat rate of 1 w/w (weight of demulsifier/weight of mud) from
Turbiscan measurements at 29° C. (1% w/w of demulsifier corresponds to 0.5 g of demulsifier in 50 g of mud)

| | concentration | | | | | | | | | |
|---|---|---|---|---|---|---|---|---|---|---|
| | weight percent | | | | | | | | | percent aqueous |
| | (weight of | | | | | | | | | phase + oil |
| | demulsifier/ | Volume percent aqueous phase after | | | | | | | | phase after |
| | weight of mud) | 2 min | 5 min | 10 min | 60 min | 6 h | 8 h | 11 h | 15 h | 21 hours |
| Example A | 1% | 34.6 | 42.1 | 45.9 | 51.42 | 56.3 | 57.5 | 59 | 60 | 61.3 |
| Example 10B | 1% | 12.2 | 19.2 | 25.8 | 39.4 | 42.4 | 45 | 46.2 | 47.7 | 49.8 |
| Example 41 | 1% | 44.8 | 51.2 | 53.5 | 58 | 59.3 | 60.1 | 60.8 | 61.5 | 62.5 |
| Example B | 1% | 45.0 | 49.0 | 50.6 | 54.4 | 57.2 | 58.3 | 59.8 | 61.0 | 63.3 |
| Example 66 | 1% | 38.5 | 42.1 | 44.2 | 48 | 51.2 | 52.2 | 53.6 | 54.7 | 55.8 |
| Example 28 | 1% | No | No | No | No | No | No | No | No | No |
| | | separation | separation | separation | separation | separation | separation | separation | separation | separation |
| Example 12 | 1% | 31.2 | 38.7 | 41.5 | 48.7 | 51.6 | 51.8 | 53.4 | 55.2 | 57.2 |
| Example 13 | 1% | 23.1 | 32.5 | 38.2 | 45.9 | 49.7 | 50.6 | 52.2 | 55.5 | 56 |
| Example 43 | 1% | 24.7 | 33.5 | 38.5 | 43.8 | 48.9 | 50 | 51 | 52.1 | 52.8 |
| Example 55 | 1% | 20.6 | 32 | 39.7 | 50.3 | 55.3 | 56.4 | 57.5 | 59.0 | 60 |
| Example 56 | 1% | 19.1 | 29.4 | 36.4 | 45.9 | 49.4 | 50.2 | 50.9 | 51.7 | 52.4 |

TABLE 2c
Amount of aqueous phase (in volume % based on the whole volume of the initial sample) versus time during the phase separation
of 50 g mud samples treated by different demulsifiers at a treat rate of 0.5 w/w (weight of demulsifier/weight of mud) from
Turbiscan measurements at 29° C. (0.5% w/w of demulsifier corresponds to 0.25 g of demulsifier in 50 g of mud)

| | concentration | | | | | | | | | |
|---|---|---|---|---|---|---|---|---|---|---|
| | weight percent | | | | | | | | | percent aqueous |
| | (weight of | | | | | | | | | phase + oil |
| | demulsifier/ | Volume percent aqueous phase after | | | | | | | | phase after |
| | weight of mud) | 2 min | 5 min | 10 min | 60 min | 6 h | 8 h | 11 h | 15 h | 21 hours |
| Example A | 0.5% | 29.7 | 37.7 | 41.7 | 47.4 | 51.3 | 52.6 | 53.9 | 54.4 | 58.4 |
| xample 10B | 0.5% | 12.8 | 21.7 | 28.5 | 41.3 | 47.3 | 48.4 | 49.3 | 50.9 | 52.5 |
| Example 41 | 0.5% | 6.4 | 20.2 | 31.5 | 44.4 | 51.8 | 53.5 | 55.3 | 57.7 | 59.4 |
| Example B | 0.5% | No | No | No | No | No | No | No | No | No |
| | | separation | separation | separation | separation | separation | separation | separation | separation | separation |
| Example 66 | 0.5% | 22.8 | 28.3 | 31.3 | 34.3 | 35.8e | 36.0 | 36.3 | 36.6 | 38.1 |
| Example 28 | 0.5% | No | No | No | No | No | No | No | No | No |
| | | separation | separation | separation | separation | separation | separation | separation | separation | separation |
| Example 12 | 0.5% | 30.9 | 37.9 | 42.1 | 48.3 | 51.5 | 52.1 | 52.8 | 54.1 | 55.6 |
| Example 13 | 0.5% | 24.4 | 34.4 | 40.4 | 48.1 | 49.9 | 50.2 | 51.33 | 52.3 | 54.1 |
| Example 43 | 0.5% | 35.4 | 40.6 | 43.7 | 46.4 | 47.1 | 47.1 | 47.1 | 47.5 | 47.5 |
| Example 55 | 0.5% | 29.8 | 38.8 | 43.4 | 50.4 | 55.2 | 55.2 | 56.5 | 57.8 | 58.7 |
| Example 56 | 0.5% | 27.7 | 36.9 | 41.2 | 47.7 | 49.1 | 49.7 | 50.4 | 51.0 | 51.4 |

TABLE 3a
Table 3a: Non volatile content and calculated total solids of the pure mud sample, of the separated
water phase and of the separated solid phase (remaining mud) after 30 min and 60 minutes (total
time after the shaking of mud treated with 2% w/w of demulsifier (based on weight of the initial
mud sample or 1 g demulsifier in addition to 50 g mud)) at 25° C.

| | non volatile | non volatile | total solid | total solid |
|---|---|---|---|---|
| | content after | content after | content after | content after |
| | 30 min (total time) | 60 min (total time) | 30 min (total time) | 60 min (total time) |
| | in percent, | in percent, | in percent, | in percent, |
| | weight percent | weight percent | weight percent | weight percent |
| | based on the | based on the | based on the | based on the |
| | initial 2 g sample | initial 2 g sample | initial 2 g sample | initial 2 g sample |
| Mud alone | 37.40% | 37.40% | | |
| Mud treated with 2% w/w of | | | | |
| Example 10B (Y-17014) | | | | |
| Separated aqueous phase (upper) | 5.8% | 10.5% | 37.0%^{a)} | 37.8%^{b)} |
| Separated solid phase (lower) | 51.7% | 53.8% | | |
| Mud treated with 2% w/w of | | | | |
| Example 41 (Y-17015) | | | | |
| Separated aqueous phase (upper) | 14.1% | 9.0% | 30.1%^{c)} | 29.9%^{c)} |
| Separated solid phase (lower) | 51.2% | 57.6% | | |

^{a)}Calculation done taking into account the percentage (in volume) of water phase separated after 30 min (total time), i.e. 32%, and 68% of remaining mud after separation (based on the whole volume of the initial mud sample).
^{b)}Calculation done taking into account the percentage (in volume) of water phase separated after 60 min (total time), i.e. 37%, and 63% of remaining mud after separation (based on the whole volume of the initial mud sample).
^{c)}Calculation done taking into account the percentage (in volume) of water phase separated after 30 min (total time), i.e. 57%, and 43% of remaining mud after separation (based on the whole volume of the initial mud sample).
^{d)} Calculation done taking into account the percentage (in volume) of water phase separated after 60 min (total time), i.e. 57%, and 43% of remaining mud after separation (based on the whole volume of the initial mud sample).

TABLE 3b
Table 3b: Weight percentage of moisture content (using the Karl Fischer method
at 25° C.) of the pure mud sample (before separation) and the separated
solid phase both after 6 h and 12 h (total time after the shaking of mud treated
with 2% (percent) by weight of demulsifier (based on weight of the initial
mud sample or 1 g in addition to 50 g mud)). Percentage moisture content is
based upon the weight of the sample being analyzed.

| | | Moisture content of |
|---|---|---|
| | | separated solid phase |
| | | (percent based on |
| | | the weight of mud |
| | | separated from water) |
| Separated solid phase after 6 hours (h) | Average | 19.03 |
| after treatment of initial mud with 2% | Standard | 0.07 |
| w/w demulsifier Example 10B (Y-17014) | deviation | |
| Separated solid phase after 6 h after | Average | 15.33 |
| treatment of initial mud with 2% w/w | Standard | 0.52 |
| demulsifier Example 41 (Y-17015) | deviation | |
| Separated solid phase after 6 h after | Average | 12.39 |
| treatment of initial mud with 2% w/w | Standard | 0.44 |
| demulsifier Example B (ref C) | deviation | |
| Separated solid phase after 6 h after | Average | 13.57 |
| treatment of initial mud with 2% w/w | Standard | 0.06 |
| demulsifier Example A (ref B) | deviation | |
| Separated solid phase after 12 h after | Average | 12.59 |
| treatment of initial mud with 2% w/w | Standard | 0.05 |
| demulsifier Example 41 (Y-17015) | deviation | |
| Separated solid phase after 12 h after | Average | 17.87 |
| treatment of initial mud with 2% w/w | Standard | 0.45 |
| demulsifier Example 10B (Y-17014) | deviation | |
| Pure Mud phase | Average | 44.48 |
| | Standard | 0.02 |
| | deviation | |

TABLE 3c
Table 3c: Titration of Silicon content by alumininum molybdate
according to the ASTM method D859-00 (Standard test method
for silica in water) in the water phases separated after treating
the mud with 2 weight % (based on weight of the initial mud
sample or 1 g of demulsifier for 50 g mud) demulsifiers (separated
water taken out after 6 or 12 h)

| Samples | | SiO2-ppm | Si-ppm |
|---|---|---|---|
| Water phase separated after | Average | 99.51 | 46.44 |
| 6 h for mud treated with 2% w/w | Standard | 1.60 | 0.74 |
| Example 10 B (Y-17014) | deviation | | |
| Water phase separated after | Average | 4429.19 | 2066.96 |
| 6 h for mud treated with 2% w/w | Standard | 765.21 | 357.10 |
| Example 41 (Y-17015) | deviation | | |
| Water phase separated after | Average | 4.15 | 1.94 |
| 6 h for mud treated with 2% w/w | Standard | 0.04 | 0.02 |
| Example A (Reference B) | deviation | | |
| Water phase separated after | Average | 790.34 | 368.82 |
| 12 h for mud treated with 2% w/w | Standard | 97.34 | 45.42 |
| Example 10 B (Y-17014) | deviation | | |
| Water phase separated after | Average | 11.60 | 5.41 |
| 6 h for mud treated with 2% w/w | Standard | 0.46 | 0.21 |
| Example B (Reference C) | deviation | | |
| Water phase separated after | Average | 3408.78 | 1590.76 |
| 12 h for mud treated with 2% w/w | Standard | 400.56 | 186.93 |
| Example 41 (Y-17015) | deviation | | |

TABLE 3d
Concentration of heavy metals in the water phase separated (both
after 6 h and 12 h (total time after the shaking of mud treated
with 2% w/w of demulsifier (based on weight of the initial mud
sample or 1 g on top of 50 g mud))) measured with an Inductively
Coupled Plasma (ICP) Atomic Emission Spectrometer

| | Trace elements |
|---|---|
| Samples | (Pb, Hg, Cd) |
| Water phase separated after 6 h for mud | <0.1 ppm |
| treated with 2% w/w Example 10 B (Y-17014) | |
| Water phase separated after 6 h for mud | <0.1 ppm |
| treated with 2% w/w Example 41 (Y-17015) | |
| Water phase separated after 6 h for mud | <0.1 ppm |
| treated with 2% w/w Example A (Reference B) | |
| Water phase separated after 12 h for mud | <0.1 ppm |
| treated with 2% w/w Example 10 B (Y-17014) | |
| Water phase separated after 6 h for mud | <0.1 ppm |
| treated with 2% w/w Example B (Reference C) | |
| Water phase separated after 12 h for mud | <0.1 ppm |
| treated with 2% w/w Example 41 (Y-17015) | |

TABLE 4
Table 4: Turbidity of the separated aqueous phase measured after
a time period of 60 min or 15 hours of phase separation for
mud samples treated by different demulsifiers at 25° C.
using the (Turbidimeter Hach 2100 test as described above) (The
demulsifier treat rate is given in % weight of demulsifier/weight
of mud). (1.5% w/w of demulsifier corresponds to 0.75 g of demulsifier
in 50 g of mud) (1% w/w of demulsifier corresponds to 0.5 g
of demulsifier in 50 g of mud)

| | Turbidity of | Turbidity of |
|---|---|---|
| | aqueous phase | aqueous phase |
| | after 60 min | after 15 hours |
| Demulsifier and Treat Rate | (NTU) | (NTU) |
| Example 10B (Y-17014) at 1% w/w | 65.1 | 32.7 |
| Example 41 (Y-17015) at 1% w/w | 99999 | 36.1 |
| Example A (Ref B) at 1% w/w | 2976 | 1522 |
| Example B (Ref C) at 1% w/w | 4207 | 2900 |
| Example 66 (or L-7280) at 1% w/w | 99999 | 1186 |
| Example 28 (or L-77) at 1.5% w/w | 99999 | 2040 |
| Example 12 (or MF 16) at 1% w/w | 51.3 | 32 |
| Example 13 (or MF 17) at 1% w/w | 674 | 272 |
| Example 56 (WARO 3601) at 1% w/w | 2097 | 1670 |
| Example 55 (WARO 2599) at 1% w/w | 2138 | 1760 |
| Example 43 (WARO 2591) at 1% w/w | 1615 | 1186 |

In conclusion, after 60 minutes of separation, Examples 10B, 12 & 13 give the best clarity of water. After 15 hours of separation, Examples 10B, 41, 12 & 13 give the best clarity of water. These results indicate that the aqueous phases do not require any flocculants to separate them further.

While the above description comprises many specifics, these specifics should not be construed as limitations, but merely as exemplifications of specific embodiments thereof. Those skilled in the art will envision many other embodiments within the scope and spirit of the description as defined by the claims appended hereto.

1. A composition comprising:
a) at least one silicone surfactant, and where silicone of silicone surfactant (a) has the general structure of:
Mₐ¹M_{b}²D_{c}¹D_{d}²Tₑ¹T_{f}²Q_{g};
where
M¹=R¹R²R³SiO_{1/2};
M²=R⁴R⁵R⁶SiO_{1/2};
D¹=R⁷R⁸SiO_{2/2};
D²=R⁹R¹⁰SiO_{2/2};
T¹=R¹¹SiO_{3/2};
T²=R¹²SiO_{3/2};
Q=SiO_{4/2}
where R¹, R², R³, R⁵, R⁶, R⁷, R⁸, R¹⁰, and R¹¹ are each independently selected from the group consisting of monovalent hydrocarbon radicals containing one to twenty carbon atoms, hydrogen, OH and OR¹³, where
R¹³ is a hydrocarbon group containing from 1 to about 4 carbon atoms,
R⁴, R⁹ and R¹² are independently hydrophilic organic groups, and
where the subscripts a, b, c, d, e, f and g are zero or positive integers for molecules subject to the following limitations:(a+b) equals either
(2+e+f+2g) or (e+f+2g), b+d+f≧1 and,
2≦(a+b+c+d+e+f+g)≦100; and,
b) a mixture comprising an aqueous phase, a solid filler phase and optionally an oil phase that is substantially insoluble in said aqueous phase.

2. The composition of claim 1 further comprising where:
R⁴, R⁹ and R¹² are independently hydrophilic organic groups selected from the group consisting of Z¹, Z², Z³, and Z⁸ where,
Z¹ is at least one polyoxyalkylene group having the general formula
B¹O(CₕH₂ₕO)ₙR¹⁴
where B¹ is an alkylene radical containing from 2 to about 4 carbon atoms
R¹⁴ is a hydrogen atom, or a hydrocarbon radical containing from 1 to about 4 carbon atoms;
n is 1 to 100;
h is 2 to 4 which provides at least one polyoxyalkylene group provided that at least about 10 molar percent of the at least one polyoxyalkylene group is polyoxyethylene;
Z² has the general formula B² (OH)ₘ
where B² is a hydrocarbon containing from 2 to about 20 carbon atoms and optionally containing oxygen and/or nitrogen groups, and m is sufficient to provide hydrophilicity,
Z³ is the reaction product of an epoxy adduct, with a hydrophilic primary or secondary amine;
Z⁸ is at least one polyoxyalkylene group having the general formula:
OB⁷O(CₕH₂ₕO)ₙR¹⁴
where B⁷ is an alkyl bridge containing from 2 to about 12 carbon atoms or an aryl bridge containing from 2 to about 12 carbon atoms;
R¹⁴ is hydrogen, or a hydrocarbon radical containing from 1 to about 4 carbon atoms;
n is 1 to 100;
h is 2 to 4, which provides at least one polyoxyalkylene group provided that at least about 10 weight percent of the at least one polyoxyalkylene group is polyoxyethylene; and wherein, 2≦(a+b+c+d+e+f+g)≦100.

3. The composition of claim 2 further comprising where silicone of silicone surfactant (a) has the general structure of:
Mₐ¹M_{b}²D_{c}¹D_{d}²
where
M¹=R¹R²R³SiO_{1/2};
M²=R⁴R⁵R⁶SiO_{1/2};
D¹=R⁷R⁸SiO_{2/2};
D²=R⁹R¹⁰SiO_{2/2};
where R¹, is selected from the group consisting of monovalent hydrocarbon radicals containing one to six carbon atoms, hydrogen, OH and OR¹³, where R¹³ is a hydrocarbon group containing from 1 to about 4 carbon atoms, and
R², R³, R⁵, R⁶, R⁷, R⁸ and R¹⁰ are each independently selected from the group consisting of monovalent hydrocarbon radicals containing one to six carbon atoms, hydrogen, OH and OR¹³,
where R¹³ is a hydrocarbon group containing from 1 to about 4 carbon atoms,
R⁴ and R⁹ are independently selected from the group consisting of Z¹, Z², Z³, and Z⁸
where, a+b is about 2 and 2≦(a+b+c+d)≦75.

4. The composition of claim 3 further comprising where the hydrophilic organic groups further comprise where R⁴, R⁹ and R¹² are independently selected from the group consisting of Z², Z⁴, Z⁶ and Z⁹, where
Z⁴ has the general formula B¹O(C₂H₄O)ₚ(C₃H₆O)_{q}R¹⁴
where B¹ is an alkylene radical containing from 2 to about 4 carbon atoms
R¹⁴ is hydrogen, or a hydrocarbon radical containing from 1 to about 4 carbon atoms, p is 1 to 15, q≦10 and p≧q;
Z⁶ is selected from the general formula of: 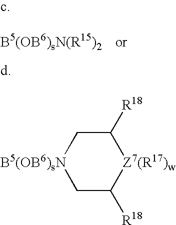
where B⁵ and B⁶ are independently hydrocarbon radicals containing from 2 to about 6 carbon atoms, which can optionally contain OH groups,
s is 0 or 1, and each R¹⁵ is independently hydrogen or an alkyleneoxide group having the general formula —(CᵤH₂ᵤO)ᵥ—R¹⁶ where u is 2 to 4 and v is 1 to 10, with the proviso that at least 50 molar percent of the alkyleneoxide groups are oxyethylene; R¹⁶ is hydrogen, or a hydrocarbon radical containing from 1 to about 4 carbon atoms; Z⁷ is either a nitrogen atom or an oxygen atom with the proviso that if Z⁷ is an oxygen atom, then w=0, and if Z⁷ is a nitrogen atom, then w=1,
R¹⁷ is independently selected from an alkyleneoxide group having the general formula —(CᵤH₂ᵤO)ᵥ—R¹⁶ where u is 2 to 4 and v is 1 to 10, with the proviso that at least about 50 molar percent of the alkyleneoxide groups are oxyethylene;
R¹⁸ groups are independently selected from the group consisting of hydrogen, OH, a hydrocarbon radical containing from 1 to about 4 carbon atoms and an alkyleneoxide group having the general formula —(CᵤH₂ᵤO)ᵥ—R¹⁶ where u is 2 to 4 and v is 1 to 10, with the proviso that at least 25 molar percent of the alkyleneoxide groups are oxyethylene;
Z⁹ has the general formula OB⁷O(C₂H₄O)ₚ(C₃H₆O)_{q}R¹⁴
where B⁷ is an alkyl bridge or an aryl bridge containing from 2 to about 12 carbon atoms, R¹⁴ is hydrogen, or a hydrocarbon radical containing from 1 to about 4 carbon atoms;
p=1 to 15, q≦10,and p≧q.

5. The composition of claim 4 where silicone of silicone surfactant (a) has the general structure of:
Mₐ¹M_{b}²D_{c}¹D_{d}²
where
M¹=R¹R²R³SiO_{1/2};
M²=R⁴R⁵R⁶SiO_{1/2};
D¹=R⁷R⁸SiO_{2/2};
D²=R⁹R¹⁰SiO_{2/2};
where R¹, is selected from the group consisting of monovalent hydrocarbon radicals containing one to six carbon atoms, hydrogen, OH and OR¹³, where R¹³ is a hydrocarbon group containing from 1 to about 4 carbon atoms, and
R², R³, R⁵, R⁶, R⁷, R⁸ and R¹⁰ are each independently selected from the group consisting of monovalent hydrocarbon radicals containing one to six carbon atoms, hydrogen, OH and OR¹³, where R¹³ is a hydrocarbon group containing from 1 to about 4 carbon atoms,
R⁴ and R⁹ are independently selected from the group consisting of Z², Z⁴, Z⁶ and
Z⁹ as described above, and a+b equals about 2 and specifically, c+d≦10 more specifically c+d≦8, and most specifically c+d≦5.

6. The composition of claim 5 further comprising where silicone of silicone surfactant (a) has the general structure of:
M²D_{c}¹M²
where
M²=R⁴R⁵R⁶SiO_{1/2};
D¹=R⁷R⁸SiO_{2/2};
where R⁵, R⁶, R⁷, and R⁸ are each independently selected from the group consisting of monovalent hydrocarbon radicals containing one to six carbon atoms, hydrogen, OH and OR¹³,
where R¹³ is a hydrocarbon group containing from 1 to about 4 carbon atoms, and
R⁴ is selected from the group consisting of Z², Z⁴, Z⁶ and Z⁹ and where c is specifically of from 0 to 10, more specifically of from 0 to 8 and most specifically of from 0 to 5.

7. The composition of claim 5 further comprising where silicone of silicone surfactant (a) has the general structure of:
M¹D_{c}¹D_{d}²M¹
where
M¹=R¹R²R³SiO_{1/2};
D¹=R⁷R⁸SiO_{2/2};
D²=R⁹R¹⁰SiO_{2/2};
where R¹, is selected from the group consisting of monovalent hydrocarbon radicals containing one to six carbon atoms, hydrogen, OH and OR¹³, where R¹³ is a hydrocarbon group containing from 1 to about 4 carbon atoms, and
R², R³, R⁷, R⁸ and R¹⁰ are each independently selected from the group consisting of monovalent hydrocarbon radicals containing one to six carbon atoms, hydrogen, OH and OR¹³, where R¹³ is a hydrocarbon group containing from 1 to about 4 carbon atoms, and
R⁹ is selected from the group consisting of Z², Z⁴, Z⁶ and Z⁹, as described above, where c is specifically of from 0 to 10, more specifically of from 0 to 5 and most specifically of from 0 to 2, and d is specifically of from 1 to 10, more specifically of from 1 to about 6 and most specifically of from 1 to 3, and in one more specific embodiment, where c is from 0 to 2 and d is from about 1 to 3.

8. The composition of claim 7 further comprising where silicone of silicone surfactant (a) is a trisiloxane and has the general structure of:
M¹D²M¹
which is obtained from the hydrosilylation of a distilled silicone polymer having the general formula M¹ D² M¹ and unsaturated started alkylene oxide in sufficient molar excess to complete the hydrosilylation reaction,
where
M¹=R¹R²R³SiO_{1/2};
D^{H}=HR¹⁰SiO_{2/2},
D²=R⁹R¹⁰SiO_{2/2};
where R¹, R², R³, and R¹⁰ are each independently selected from the group consisting of monovalent hydrocarbon radicals containing from 1 to 6 carbon atoms, hydrogen, OH and OR¹³; where R¹³ is a hydrocarbon group containing from 1 to about 4 carbon atoms and R⁹ is selected from the group consisting of Z², Z⁴, Z⁶ and Z⁹.

9. The composition of claim 6 further comprising where silicone surfactant (a) is a low molecular weight ABA siloxane block copolymer where silicone of silicone surfactant (a) has the general structure M^{R}D_{c}¹M^{R} which is obtained from the hydrosilylation of silicone polymer having the general formula M^{H}D_{c}¹M^{H} and unsaturated started alkylene oxide and present, in sufficient molar excess to complete the hydrosilylation reaction, where c is 0 to 10, D¹=R⁷R⁸SiO_{2/2}, M^{R}=R⁴R⁵R⁶SiO_{1/2}, M^{H}=HR⁵R⁶SiO_{1/2} and where R⁵, R⁶, R⁷, and R⁸ are each independently selected from the group consisting of monovalent hydrocarbon radicals containing one to six carbon atoms, hydrogen, OH and OR¹³, where R¹³ is a hydrocarbon group containing from 1 to about 4 carbon atoms,
and where R⁴ is
C_{g}H_{2g}—O(C₂H₄O)ₚ(C₃H₆O)_{q}R¹⁴ and where R¹⁴ is, hydrogen, or a hydrocarbon radical containing from 1 to about 4 carbon atoms; g=2 to 4; p=1 to 12; q≦6; and p≧q.

10. The composition of claim 7 further comprising where silicone surfactant (a) is a low molecular weight pendant siloxane copolymer where silicone of silicone surfactant (a) has the general structure M¹D_{c}¹D_{d}^{R}M¹ which is obtained from the hydrosilylation of silicone polymer having the general formula M¹D_{c}¹D_{d}^{H}M¹ and unsaturated started alkylene oxide in sufficient molar excess to complete the hydrosilylation reaction,
where M¹=R¹R²R³SiO_{1/2}, D¹=R⁷R⁸SiO_{2/2}, D^{R}=R⁹R¹⁰SiO_{2/2}, D^{H}=HR¹⁰SiO_{2/2}, and where c is of from 0 to 10, and d is specifically of from 1 to 10, where R¹ is selected from the group consisting of monovalent hydrocarbon radicals containing one to six carbon atoms, hydrogen, OH and OR¹³, where R¹³ is a hydrocarbon group containing from 1 to about 4 carbon atoms, and
R², R³, R⁷, R⁸ and R¹⁰ are each independently selected from the group consisting of monovalent hydrocarbon radicals containing one to six carbon atoms, hydrogen, OH and OR¹³, where R¹³ is a hydrocarbon group containing from 1 to about 4 carbon atoms,
and where R⁹ is independently C_{g}H_{2g}—O(C₂H₄O)ₚ(C₃H₆O)_{q}R¹⁴ and where R¹⁴ is hydrogen, or a hydrocarbon radical containing from 1 to about 4 carbon atoms; g=2 to 4; p=1 to 12; q≦6; and p≧q.

11. The composition of claim 10 further comprising where silicone surfactant (a) is a trisiloxane siloxane copolymer where silicone of silicone surfactant (a) has the general structure M¹D^{R}M¹ which is obtained from the hydrosilylation of a distilled silicone polymer having the general formula M¹D^{H}M¹ and unsaturated started alkylene oxide in sufficient molar excess to complete the hydrosilylation reaction, where M¹=R¹R²R³SiO_{1/2}, D^{R}=R⁹R¹⁰SiO_{2/2}, D^{H}=HR¹⁰SiO_{2/2}, where R¹, R², R³, and R¹⁰, are each independently selected from the group consisting of CH₃, hydrogen, OH and OR¹³, and where R¹³ is a hydrocarbon group containing from 1 to about 4 carbon atoms, and where R⁹ is C_{g}H_{2g}—O(C₂H₄O)ₚ(C₃H₆O)_{q}R¹⁴, and where R¹⁴ is hydrogen, or a hydrocarbon radical containing from 1 to about 4 carbon atoms; g=2 to 4; p=1 to 12; q≦6; and p≧q.

12. The composition of claim 1 further comprising where silicone surfactant (a) is used at a concentration of from about 0.001 weight percent to about 5 weight percent based on total weight of composition to enhance phase separation.

13. The composition of claim 2 further comprising where silicone surfactant (a) is used at a concentration of from about 0.001 weight percent to about 5 weight percent based on total weight of composition to enhance phase separation.

14. The composition of claim 3 further comprising where silicone surfactant (a) is used at a concentration of from about 0.001 weight percent to about 5 weight percent based on total weight of composition to enhance phase separation.

15. The composition of claim 4 further comprising where silicone surfactant (a) is used at a concentration of from about 0.001 weight percent to about 5 weight percent based on total weight of composition to enhance phase separation.

16. The composition of claim 5 further comprising where silicone surfactant (a) is used at a concentration of from about 0.001 weight percent to about 5 weight percent based on total weight of composition to enhance phase separation.

17. The composition of claim 6 further comprising where silicone surfactant (a) is used at a concentration of from about 0.001 weight percent to about 5 weight percent based on total weight of composition to enhance phase separation.

18. The composition of claim 1 further comprising where mixture (b) can be any known or commercially and/or industrially used mixture that is naturally present or is conventionally added through known and/or conventional methods.

19. The composition of claim 1 further comprising where mixture (b) can comprise a drilling mud, a shale oil deasher sludge, a refinery sludge, a soil from a refinery and/or industrial site, a soil from the site of leaking fuel storage tank, a slop crude mixture, a pharmaceutical emulsion, a tar-oil sand, and combinations thereof.

20. The composition of claim 1 further comprising where mixture (b) is a mixture selected from the group consisting of a mixture resulting from an oil spill, a mixture resulting from a pipeline break, a mixture resulting from a leaking fuel tank, a mixture resulting from an industrial operation, and combinations thereof.

21. The composition of claim 1 further comprising where aqueous phase can be any known or commercially and/or industrially used aqueous phase that is naturally present or is conventionally added through known and/or conventional methods.

22. The composition of claim 1 further comprising where aqueous phase of mixture (b) contains water in an amount of from about 1 to about 99 weight percent, with weight percent being based upon the total weight of mixture (b).

23. The composition of claim 22 further comprising where water further comprises inorganic salt selected from the group consisting of sodium chloride, calcium chloride, magnesium chloride, sodium sulfates, magnesium sulfate, sodium carbonate, calcium carbonate, magnesium carbonate and combinations thereof in an amount of up to about saturation of aqueous phase.

24. The composition of claim 1 further comprising where aqueous phase of mixture (b) also contains additional silicone surfactant.

25. The composition of claim 1 further comprising where solid filler phase of mixture (b) is naturally present or is conventionally added through known and/or conventional methods.

26. The composition of claim 25 further comprising where solid filler phase of mixture (b) comprises solid filler selected from the group consisting of drill cuttings; siliceous solid; rock; gravel; soil; ash; mineral; metal and metal ores; a metal part; a glass plate; cellulosic material; weighting agent; suspending agent; fluid loss control agent; and combinations thereof.

27. The composition of claim 25 further comprising where solid filler phase comprises from about 1 to about 99 weight percent, of mixture (b), based on the total weight of mixture (b).

28. The composition of claim 26 further comprising where drill cuttings comprise from about 0 to about 25 weight percent of mixture (b) based on the total weight of mixture (b).

29. The composition of claim 1 further comprising where solid filler phase of mixture (b) also contains additional silicone surfactant.

30. The composition of claim 1 further comprising where mixture (b) further comprises additional component selected from the group consisting of proppant; wetting agent; temperature stabilizing additive; sulfonated polymers and copolymers; lignite; lignosulfonate; tannin-based additives; emulsifier; alkalinity and pH control additives; bactericides; flocculants; rheology modifier; filtrate reducers and/or fluid loss reducers shale control inhibitors; lubricant; and combinations thereof.

31. The composition of claim 1 further comprising where oil phase can be any known or commercially and/or industrially used oil phase that is naturally present or is conventionally added through known and/or conventional methods.

32. The composition of claim 1 further comprising where oil phase comprises a hydrocarbon.

33. The composition of claim 1 further comprising where oil phase comprises petroleum oil fraction, natural or synthetic oil, fat, grease, wax, synthetic oil-containing silicone, grease-containing silicone, and combinations thereof.

34. The composition of claim 33 further comprising where petroleum oil fraction is a natural or synthetic petroleum or petroleum product, selected from the group consisting of crude oil, heating oil, bunker oil, kerosene, diesel fuel, aviation fuel, gasoline, naphtha, shale oil, coal oil, tar-oil, lubricating oil, motor oil, mineral oil, ester oil, glyceride of fatty acid, aliphatic ester, aliphatic acetal, solvent, lubricating grease and combinations thereof.

35. The composition of claim 1 further comprising where oil phase of mixture (b) also contains additional silicone surfactant.

36. The composition of claim 1 further comprising where oil phase comprises from about 1 to about 90 weight percent of mixture (b) based on total weight of mixture (b).
